(19) United States
(12) Patent Application Publication
(10) Pub. No.: US 2016/0210681 A1
(43) Pub. Date: Jul. 21, 2016

(54) PRODUCT RECOMMENDATION DEVICE, PRODUCT RECOMMENDATION METHOD, AND RECORDING MEDIUM

(71) Applicant: NEC CORPORATION, Tokyo (JP)

(72) Inventors: Yosuke MOTOHASHI, Tokyo (JP); Koutarou OCHIAI, Tokyo (JP); Norihito GOTO, Tokyo (JP)

(73) Assignee: NEC Corporation, Tokyo (JP)

(21) Appl. No.: 15/022,843

(22) PCT Filed: Aug. 21, 2014
(86) PCT No.: PCT/JP2014/004277

§ 371 Date: Mar. 17, 2016

(30) Foreign Application Priority Data
Sep. 20, 2013 (JP) 2013-195966

(51) Int. Cl. G06Q 30/06

(52) U.S. Cl. CPC G06Q 30/0631

(57) ABSTRACT

This invention discloses a product recommendation device that recommends products that are selling well in many stores, not products that are selling well in only some stores. For each of a plurality of products sold at a plurality of stores, a score computation unit (90) computes a score that increases as a function of both shipment volume and the number of stores at which the product in question is being dealt. A product recommendation unit (91) recommends products that have higher scores than products being dealt at the store for which the recommendation is being made.

### TECHNICAL FIELD

The present invention relates to a product recommendation device, a product recommendation method, and a recording medium.

### BACKGROUND ART

As disclosed in NPL 1, ABC analysis is one of techniques for recommending products to be sold at stores. With ABC analysis, products to be sold at stores are ranked based on the sales to manage the inventories and recommend new products on the basis of the ranking result.

NPL 2 disclose methods for determining the type of observation probability by approximating the complete marginal likelihood function for a mixture model that typifies the latent variable model and, then, maximizing its lower bound (lower limit).

### CITATION LIST

### Patent Literature

[PTL 1] Japanese Patent No. 4139410
[PTL 2] Japanese Unexamined Patent Application Publication No. 2010-128779
[PTL 3] International Publication WO 2012/128207

### Non Patent Literature

[NPL 1] “ABC analysis”, [online], Wikipedia, [searched at Sep. 19, 2013] Internet <URL: http://en.wikipedia.org/wiki/ABC_analysis)>
[NPL 2] Ryohei Fujimaki, Satoshi Morinaga: Factorized Asymptotic Bayesian Inference for Mixture Modeling. Proceedings_of_the_fifteenth_international_conference_on_Artificial_Intelligence_and_Statistics (AISTATS), March 2012.

### SUMMARY OF INVENTION

### Technical Problem

ABC analysis has a problem: in, for example, recommending an assortment of merchandise for products to be sold at a plurality of stores, products that are sold at only a few stores and selling well only in some stores are recommended.

It is a main object of the present invention to provide a product recommendation device, a product recommendation method, and a recording medium that solve the above-described problems.

### Solution to Problem

The first aspect is a product recommendation device which recommends a product to be dealt at a store, the device comprising:

score computation means for computing a score which increases in accordance with a shipment-volume and the number of stores at which a product in question is being dealt, for each of a plurality of products being dealt at a plurality of stores; and

product recommendation means for recommending a product, the score of which is higher than the score of a product being dealt at the store for which the recommendation is being made.

The second aspect is a product recommendation method comprising:

using an information processing apparatus to compute a score which increases in accordance with a shipment-volume and the number of stores at which a product in question is being dealt, for each of a plurality of products being dealt at a plurality of stores; and thereby recommend a product, the score of which is higher than the score of a product being dealt at a store for which the recommendation is being made.

The third aspect is a recording medium recording a program for causing a computer to execute,

a score computation function of computing a score which increases in accordance with a shipment-volume and the number of stores at which a product in question is being dealt, for each of a plurality of products being dealt at a plurality of stores; and

a product recommendation function of recommending a product, the score of which is higher than the score of a product being dealt at a store for which the recommendation is being made.

### Advantageous Effects of Invention

According to the above-mentioned aspects, in place of products that are selling well only in some stores, products that are hot-selling in many stores can be recommended.

### BRIEF DESCRIPTION OF DRAWINGS

FIG. 1 is a block diagram illustrating an exemplary configuration of a shipment-volume prediction system according to at least one exemplary embodiment of the present invention.

FIG. 2A is a table illustrating an example of information stored in a learning database according to at least one exemplary embodiment of the present invention.

FIG. 2B is a table illustrating another example of the information stored in the learning database according to at least one exemplary embodiment of the present invention.

FIG. 2C is a table illustrating still another example of the information stored in the learning database according to at least one exemplary embodiment of the present invention.

FIG. 2D is a table illustrating still another example of the information stored in the learning database according to at least one exemplary embodiment of the present invention.

FIG. 2E is a table illustrating still another example of the information stored in the learning database according to at least one exemplary embodiment of the present invention.

FIG. 2F is a table illustrating still another example of the information stored in the learning database according to at least one exemplary embodiment of the present invention.

FIG. 2G is a table illustrating still another example of the information stored in the learning database according to at least one exemplary embodiment of the present invention.

FIG. 3 is a block diagram illustrating an exemplary configuration of a hierarchical latent variable model estimation device according to at least one exemplary embodiment of the present invention.

FIG. 4 is a block diagram illustrating an exemplary configuration of a hierarchical latent variable variational probability computation unit according to at least one exemplary embodiment of the present invention.

FIG. 5 is a block diagram illustrating an exemplary configuration of a gating function optimization unit according to at least one exemplary embodiment of the present invention.

FIG. 6 is a flowchart illustrating an exemplary operation of the hierarchical latent variable model estimation device according to at least one exemplary embodiment of the present invention.

FIG. 7 is a flowchart illustrating an exemplary operation of the hierarchical latent variable variational probability computation unit according to at least one exemplary embodiment of the present invention.

FIG. 8 is a flowchart illustrating an exemplary operation of the gating function optimization unit according to at least one exemplary embodiment of the present invention.

FIG. 9 is a block diagram illustrating an exemplary configuration of a shipment-volume prediction device according to at least one exemplary embodiment of the present invention.

FIG. 10 is a flowchart illustrating an exemplary operation of the shipment-volume prediction device according to at least one exemplary embodiment of the present invention.

FIG. 11 is a block diagram illustrating an exemplary configuration of another hierarchical latent variable model estimation device according to at least one exemplary embodiment of the present invention.

FIG. 12 is a block diagram illustrating an exemplary configuration of a hierarchical latent structure optimization unit according to at least one exemplary embodiment of the present invention.

FIG. 13 is a flowchart illustrating an exemplary operation of the hierarchical latent variable model estimation device according to at least one exemplary embodiment of the present invention.

FIG. 14 is a flowchart illustrating an exemplary operation of the hierarchical latent structure optimization unit according to at least one exemplary embodiment of the present invention.

FIG. 15 is a block diagram illustrating an exemplary configuration of another gating function optimization unit according to at least one exemplary embodiment of the present invention.

FIG. 16 is a flowchart illustrating an exemplary operation of the gating function optimization unit according to at least one exemplary embodiment of the present invention.

FIG. 17 is a block diagram illustrating an exemplary configuration of another shipment-volume prediction device according to at least one exemplary embodiment of the present invention.

FIG. 18A is a flowchart illustrating an exemplary operation (1/2) of the shipment-volume prediction device according to at least one exemplary embodiment of the present invention.

FIG. 18B is a flowchart illustrating another exemplary operation (2/2) of the shipment-volume prediction device according to at least one exemplary embodiment of the present invention.

FIG. 19 is a block diagram illustrating an exemplary configuration of still another shipment-volume prediction device according to at least one exemplary embodiment of the present invention.

FIG. 20 is a block diagram illustrating an exemplary configuration of another shipment-volume prediction system according to at least one exemplary embodiment of the present invention.

FIG. 21 is a block diagram illustrating an exemplary configuration of a product recommendation device according to at least one exemplary embodiment of the present invention.

FIG. 22 is a chart illustrating an exemplary tendency of sales of products in a cluster.

FIG. 23 is a flowchart illustrating an exemplary operation of the product recommendation device according to at least one exemplary embodiment of the present invention.

FIG. 24 is a block diagram illustrating the basic configuration of a product recommendation device.

FIG. 25 is a schematic block diagram illustrating the configuration of a computer according to at least one exemplary embodiment of the present invention.

### DESCRIPTION OF EMBODIMENTS

The hierarchical latent variable model referred to in this description is defined as a probability model having latent variables represented by a hierarchical structure (for example, a tree structure). Components representing probability models are assigned to the nodes at the lowest level of the hierarchical latent variable model. Gating functions (gating function models) as criteria for selecting nodes in accordance with input information are allocated to nodes (intermediate nodes; to be referred to as “branch nodes” hereinafter, for the sake of convenience in taking a tree structure as an example) other than the nodes at the lowest level.

A process by a shipment-volume prediction device and other details will be described hereinafter with reference to a two-level hierarchical latent variable model taken as example. For the sake of descriptive convenience, the hierarchical structure is assumed to be a tree structure. However, in the present invention to be set forth by taking the following exemplary embodiments as an example, the hierarchical structure is not always a tree structure.

When the hierarchical structure is assumed to be a tree structure, course from the root node to a certain node is only one because the tree structure has no loop. The course (link) from the root node to a certain node in the hierarchical latent structure will be referred to as a “path” hereinafter. Path latent variables are determined by tracing the latent variables for each path. For example, a lowest-level path latent variable is defined as a path latent variable determined for each path from the root node to the node at the lowest level.

The following description assumes that a data sequence xⁿ (n=1, . . . , N) is input. It is assumed that each xⁿ is defined as an M-dimensional multivariate data sequence (xⁿ=x₁ⁿ, . . . , x_{M}ⁿ). The data sequence xⁿ also sometimes serves as an observation variable. A first-level branch latent variable zᵢⁿ, a lowest-level branch latent variable z_{j|i}ⁿ, and a lowest-level path latent variable zᵢⱼⁿ for the observation variable xⁿ are defined as follows.

zᵢⁿ=1 means that a branch to the i-th node at the first level takes place when a node is selected based on xⁿ input to the root node. zᵢⁿ=0 means that no branch to the i-th node at the first level takes place when a node is selected based on xⁿ input to the root node. z_{j|i}ⁿ=1 means that a branch to the j-th node at the second level takes place when a node is selected based on xⁿ input to the i-th node at the first level. z_{j|i}ⁿ=0 means that no branch to the j-th node at the second level takes place when a node is selected based on xⁿ input to the i-th node at the first level.

zᵢⱼⁿ=1 means that a branch to a component traced by passing through the i-th node at the first level and the j-th node at the second level takes place when a node is selected based on xⁿ input to the root node. zᵢⱼⁿ=0 means that no branch to a component traced by passing through the i-th node at the first level and the j-th node at the second level takes place when a node is selected based on xⁿ input to the root node.

Since Σᵢzᵢⁿ=1, Σⱼz_{j|i}ⁿ=1, and zᵢⱼⁿ=zᵢⁿ·z_{j|i}ⁿ are satisfied, we have zᵢⁿ=Σⱼzᵢⱼⁿ. A combination of x and the representative value z of the lowest-level path latent variable zᵢⱼⁿ is called a “complete variable.” In contrast to this, x is called an incomplete variable.

Eqn. 1 represents a hierarchical latent variable model joint distribution of depth 2 for a complete variable.

$${ ( Eqn . 1 ) \\ p ( {x}^{N} , {z}^{N} \vert M ) = p ( {x}^{N} , {z}_{1 st}^{N} , {z}_{2 nd}^{N} \vert M ) =}_{ }^{ } {\int }_{ }^{ } {\prod }_{n = 1}^{N} \{ p ( {z}_{1 st}^{n} \vert β ) {\prod }_{i = 1}^{{K}_{1}} {p ( {z}_{2 nd \vert i}^{n} \vert {β}_{i} )}^{{x}_{i}^{n}} {\prod }_{i = 1}^{{K}_{1}} {\prod }_{j = 1}^{{K}_{2}} {p ( {x}^{n} \vert {φ}_{ij} )}^{{z}_{i}^{n} {z}_{j \vert i}^{n}} \} d θ$$

In other words, P(x, y)=P(x, z₁ₛₜ, z_{2nd}) in Eqn. 1 represents a hierarchical latent variable model joint distribution of depth 2 for a complete variable. In Eqn. 1, z₁ₛₜⁿ is the representative value of zᵢⁿ and z_{2nd}ⁿ is the representative value of z_{j|i}ⁿ. The variational distribution for the first-level branch latent variable zᵢⁿ is represented as q(zᵢⁿ) and the variational distribution for the lowest-level path latent variable zᵢⱼⁿ is represented as q(zᵢⱼⁿ).

In Eqn. 1, K₁ is the number of nodes in the first level and K₂ is the number of nodes branched from each node at the first level. In this case, a component at the lowest level is expressed as K₁·K₂. Let θ=(β, β₁, . . . , β_{K1}, φ₁, . . . φ_{K1·K2}) be the model parameter, where β is the branch parameter of the root node, βₖ is the branch parameter of the k-th node at the first level, and φₖ is the observation parameter for the k-th component.

Let S₁, . . . , S_{K1·K2} be the type of observation probability for φₖ. In the case of, for example, a multivariate data generation probability, examples of candidates for S₁ to S_{K1·K2} may include {normal distribution, lognormal distribution, exponential distribution}. Alternatively, when, for example, a polynomial curve is output, examples of candidates for S₁ to S_{K1·K2} may include {zeroth-order curve, linear curve, quadratic curve, cubic curve}.

A hierarchical latent variable model of depth 2 will be taken as a specific example hereinafter. However, the hierarchical latent variable model according to at least one exemplary embodiment is not limited to a hierarchical latent variable model of depth 2 and may be defined as a hierarchical latent variable model of depth 1 or 3 or more. In this case, as well as a hierarchical latent variable model of depth 2, Eqn. 1 and Eqns. 2 to 4 (to be described later) need only be derived, thereby implementing an estimation device with a similar configuration.

A distribution having X as a target variable will be described hereinafter. However, the same applies to the case where the observation distribution serves as a conditional model P(Y|X) (Y is the target probability variable), as in regression or determination.

Before a description of exemplary embodiments of the present invention, the essential difference between an estimation device according to any of these exemplary embodiments and the estimation method for a mixture latent variable model described in NPL 2 will be described below.

The method disclosed in NPL 2 assumes a general mixture model having the latent variable as an indicator for each component. Then, an optimization criterion is derived, as presented in Eqn. 10 of NPL 2. However, given a Fisher information matrix expressed as Eqn. 6 in NPL 2, the method described in NPL 2 postulates that the probability distribution of the latent variable serving as an indicator for each component depends only on the mixture ratio in the mixture model. Therefore, since the components cannot be switched in accordance with input, this optimization criterion is inappropriate.

To solve this problem, it is necessary to set hierarchical latent variables and perform computation involved in accordance with an appropriate optimization criterion, as will be shown in the following exemplary embodiments. The following exemplary embodiments assume that a multi-level singular model for selecting branches at respective branch nodes in accordance with input is used as such an appropriate optimization criterion.

Exemplary embodiments will be described below with reference to the accompanying drawings.

### First Exemplary Embodiment

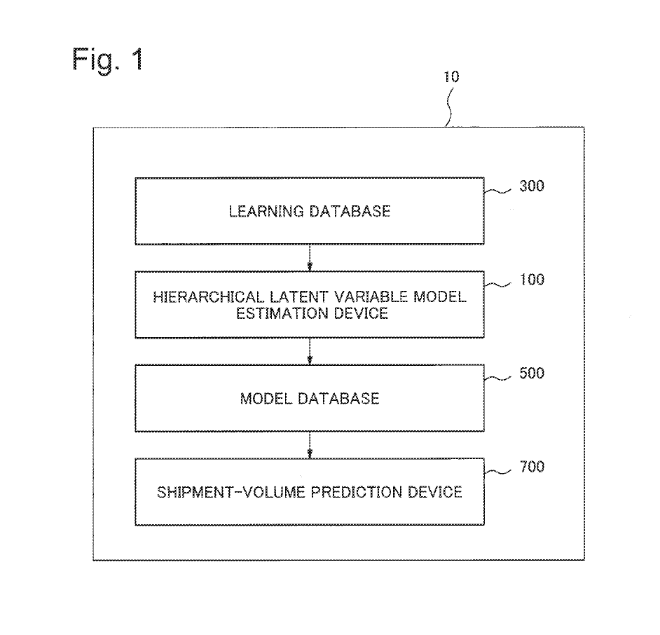

FIG. 1 is a block diagram illustrating an exemplary configuration of a shipment-volume prediction system according to at least one exemplary embodiment. A shipment-volume prediction system 10 according to this exemplary embodiment includes an estimation device 100 of a hierarchical latent variable model (a hierarchical latent variable model estimation device 100), a learning database 300, a model database 500, and a shipment-volume prediction device 700. The shipment-volume prediction system 10 generates a model for predicting the shipment-volume based on information concerning the past shipment of a product to predict the shipment-volume using the model.

The hierarchical latent variable model estimation device 100 estimates a model for predicting the shipment-volume of a product using data stored in the learning database 300 and stores the model in the model database 500.

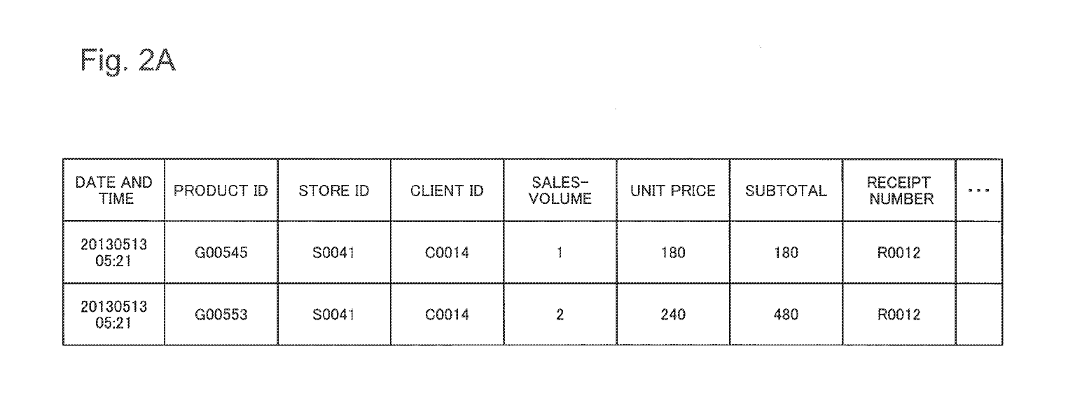

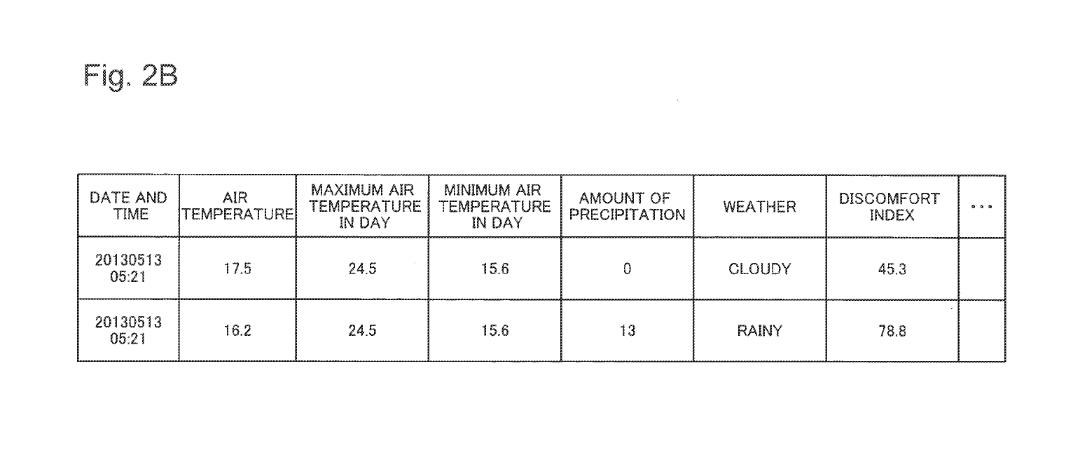

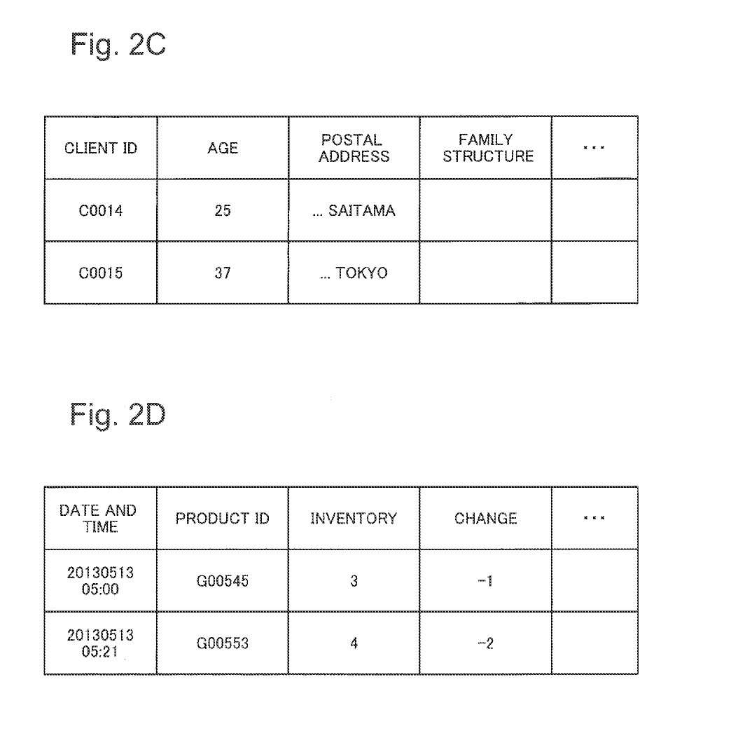

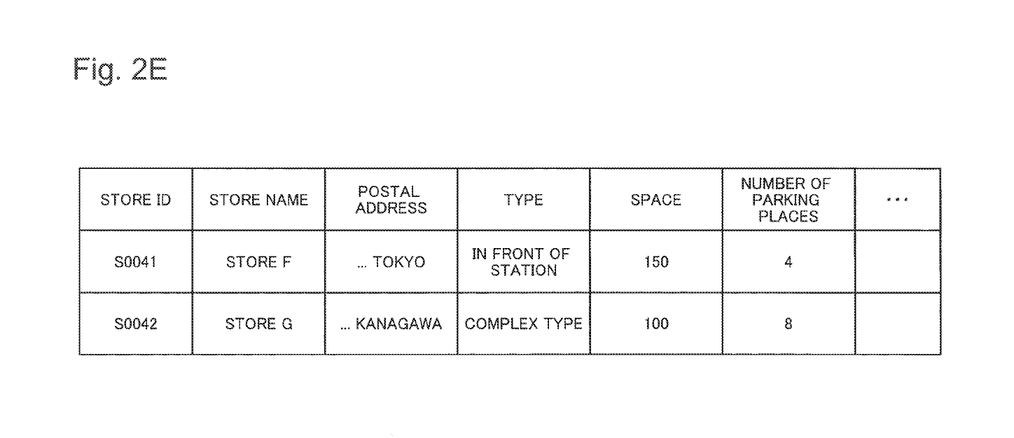

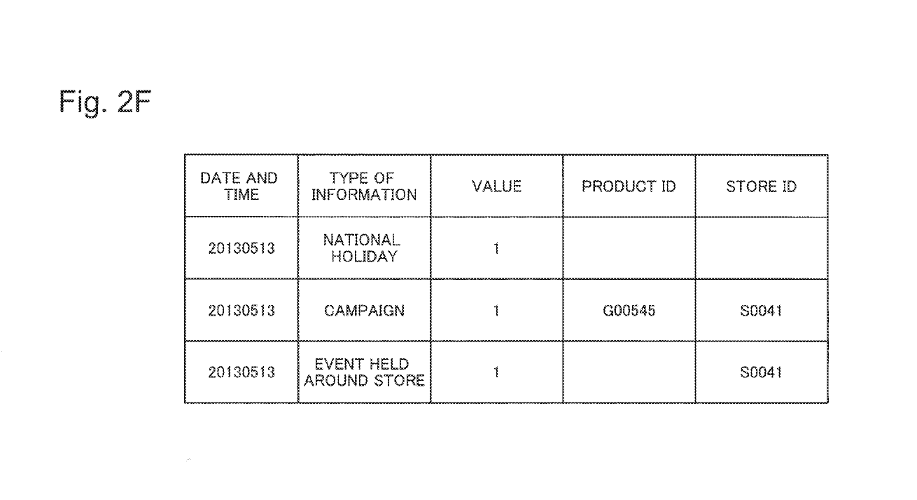

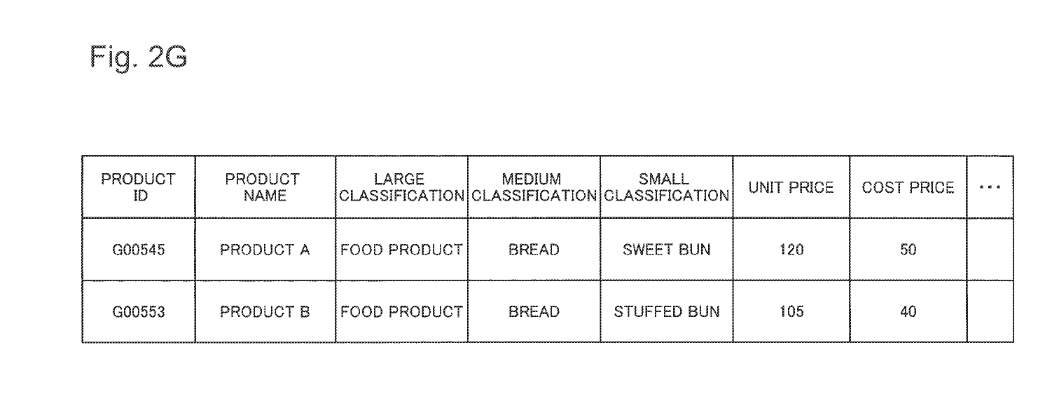

FIGS. 2A to 2G are tables illustrating examples of information stored in the learning database 300 according to at least one exemplary embodiment.

The learning database 300 stores data associated with products and stores.

The learning database 300 can store a shipment table capable of storing data associated with shipment of products. The shipment table stores, for example, the sales-volume, unit price, subtotal, and receipt number of a product in association with a combination of the date and time, the product identifier (to be abbreviated as the “ID” hereinafter), the store ID, and the client ID, as illustrated in FIG. 2A. The client ID is information that allows unique identification of individual clients and can be specified by, for example, presenting a membership card or a reward card.

The learning database 300 can further store a meteorological table capable of storing data associated with meteorological phenomena. The meteorological table stores, for example, the air temperature, the maximum air temperature in the day, the minimum air temperature in the day, the amount of precipitation, the weather, and the discomfort index in association with the date and time, as illustrated in FIG. 2B.

The learning database 300 can further store a client table capable of storing data associated with clients who have purchased products. The client table stores, for example, the age, the postal address, and the family structure in association with the client ID, as illustrated in FIG. 2C. In this exemplary embodiment, these types of information are stored in response to registering, for example, a membership card or a reward card.

The learning database 300 can further store an inventory table capable of storing data associated with the inventories of products. The inventory table stores, for example, the inventory and the change in inventory from the previous time in association with a combination of the date and time and the product ID, as illustrated in FIG. 2D.

The learning database 300 can further store a store attribute table capable of storing data associated with stores. The store attribute table stores, for example, the store name, the postal address, the type, the space, and the number of parking places in association with the store ID, as illustrated in FIG. 2E. Examples of the type of store may include an in-front-of-station type in which a store is located in front of a station, a residential street type in which a store is located in a residential street, and a complex type that is a complex facility combined with other facilities such as a gas station.

The learning database 300 can further store a date-and-time attribute table capable of storing data associated with the date and time. The date-and-time attribute table stores, for example, the type of information indicating the attribute of the date and time, the value, the product ID, and the store ID in association with this date and time, as illustrated in FIG. 2F. Examples of the type of information may include information indicating whether the day of interest is a national holiday, information indicating whether a campaign is under way, and information indicating whether an event is held around the store. The value of the date-and-time attribute table takes 1 or 0. When the value takes 1, the date and time associated with this value has the attribute indicated by the type of information associated with this value. When the value takes 0, the date and time associated with this value does not have the attribute indicated by the type of information associated with this value. The necessity/non-necessity of the product ID and the store ID varies depending on the type of information. For example, when the type of information indicates a campaign, the product ID and the store ID are necessary because a store which practices a campaign and a product targeted in the campaign need to be identified. On the other hand, when the type of information indicates a national holiday, the product ID and the store ID are unnecessary because the distinction between individual stores and the type of product are irrelevant to the information indicating whether the day of interest is a national holiday.

The learning database 300 further stores a product attribute table capable of storing data associated with products. The product attribute table stores, for example, the product name and the large, medium, and small classifications of products, the unit price, and the cost price in association with the product ID, as illustrated in FIG. 2G.

The model database 500 stores a model for predicting the shipment-volume of a product estimated by the hierarchical latent variable model estimation device. The model database 500 is implemented with a non-transitory tangible medium such as a hard disk drive or a solid-state drive.

The shipment-volume prediction device 700 receives data associated with a product and a store and predicts the shipment-volume of the product based on these data and the model stored in the model database 500.

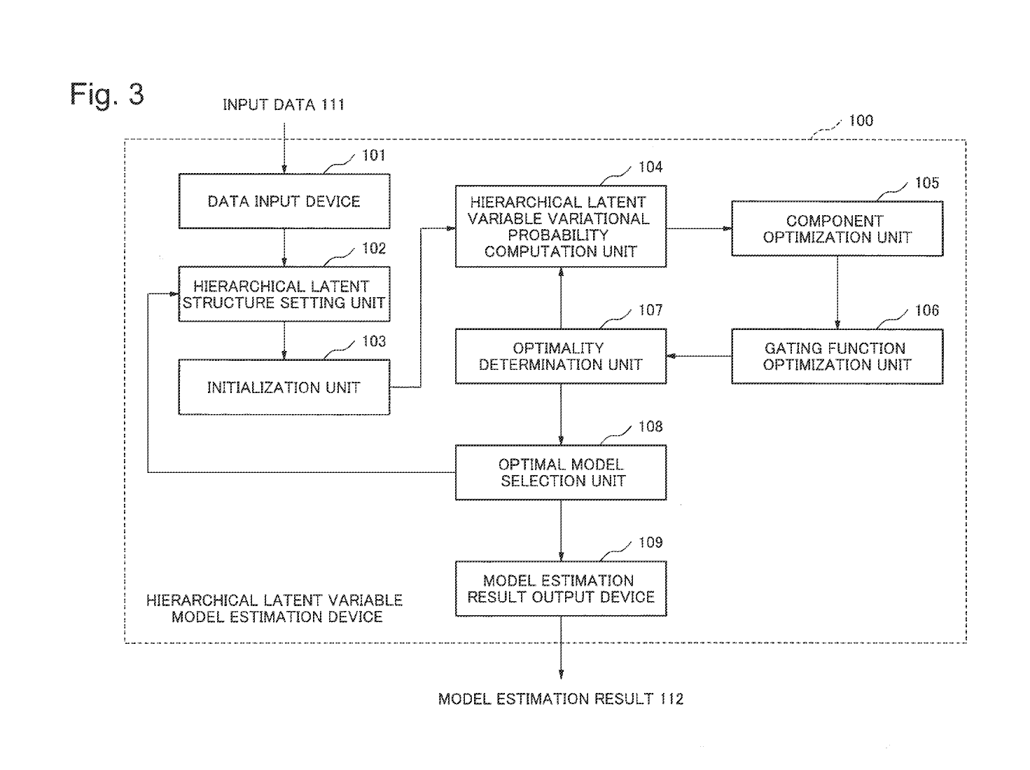

FIG. 3 is a block diagram illustrating an exemplary configuration of the hierarchical latent variable model estimation device according to at least one exemplary embodiment. The hierarchical latent variable model estimation device 100 according to this exemplary embodiment includes a data input device 101, a setting unit 102 of a hierarchical latent structure (a hierarchical latent structure setting unit 102), an initialization unit 103, a calculation processing unit 104 of a variational probability of a hierarchical latent variable (a hierarchical latent variable variational probability computation unit 104), and an optimization unit 105 of a component (a component optimization unit 105). The hierarchical latent variable model estimation device 100 further includes a optimization unit 106 of a gating function (a gating function optimization unit 106), an optimality determination unit 107, an optimal model selection unit 108, and an output device 109 of a model estimation result (a model estimation result output device 109).

Upon receiving input data 111 generated based on the data stored in the learning database 300, the hierarchical latent variable model estimation device 100 optimizes the hierarchical latent structure and the type of observation probability for the input data 111. The hierarchical latent variable model estimation device 100 then outputs the optimization result as a model estimation result 112 and stores it in the model database 500. In this exemplary embodiment, the input data 111 exemplifies learning data.

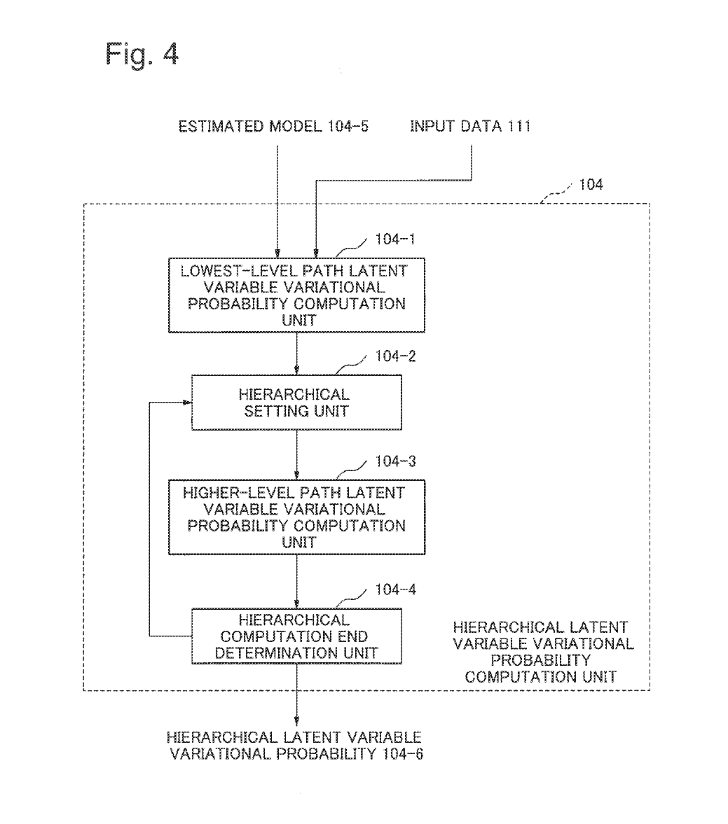

FIG. 4 is a block diagram illustrating an exemplary configuration of the hierarchical latent variable variational probability computation unit 104 according to at least one exemplary embodiment. The hierarchical latent variable variational probability computation unit 104 includes a calculation processing unit 104-1 of a variational probability of a lowest-level path latent variable (a lowest-level path latent variable variational probability computation unit 104-1), a hierarchical setting unit 104-2, a calculation processing unit 104-3 of a variational probability of a higher-level path latent variable (a higher-level path latent variable variational probability computation unit 104-3), and a determination unit 104-4 of an end of a hierarchical calculation processing (a hierarchical computation end determination unit 104-4).

The hierarchical latent variable variational probability computation unit 104 outputs a hierarchical latent variable variational probability 104-6 based on the input data 111, and an estimated model 104-5 in the component optimization unit 105 for a component (to be described later). The hierarchical latent variable variational probability computation unit 104 will be described in more detail later. The component in this exemplary embodiment is defined as a value indicating the weight applied to each explanatory variable. The shipment-volume prediction device 700 can obtain a target variable by computing the sum of explanatory variables each multiplied by the weight indicated by the component.

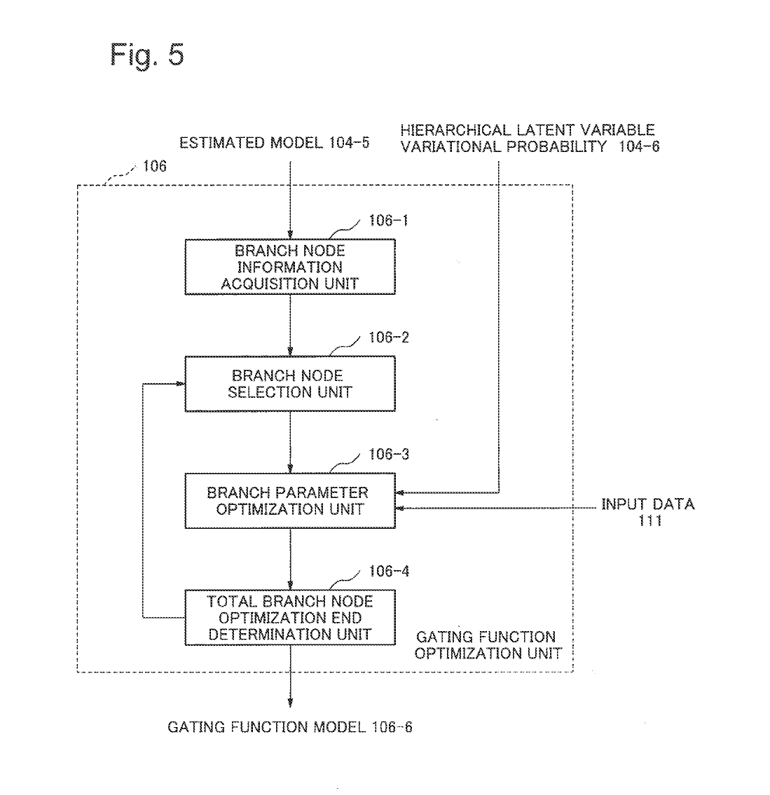

FIG. 5 is a block diagram illustrating an exemplary configuration of the gating function optimization unit 106 according to at least one exemplary embodiment. The gating function optimization unit 106 includes an information acquisition unit 106-1 of a branch node (a branch node information acquisition unit 106-1), a selection unit 106-2 of a branch node (a branch node selection unit 106-2), a optimization unit 106-3 of a branch parameter (a branch parameter optimization unit 106-3), and a determination unit 106-4 of an end of optimization of a total branch node (a total branch node optimization end determination unit 106-4).

Upon receiving input data 111, a hierarchical latent variable variational probability 104-6, and an estimated model 104-5, the gating function optimization unit 106 outputs a gating function model 106-6. The hierarchical latent variable variational probability computation unit 104 (to be described later) computes the hierarchical latent variable variational probability 104-6. The component optimization unit 105 computes the estimated model 104-5. The gating function optimization unit 106 will be descried in more detail later. The gating function in this exemplary embodiment is used to determine whether the information in the input data 111 satisfies a predetermined condition. The gating function is set at an internal node of the hierarchical latent structure. In tracing the path from the root node to the node at the lowest level, the shipment-volume prediction device 700 determines a node to be traced next in accordance with the determination result based on the gating function.

The data input device 101 receives the input data 111. The data input device 101 calculates a target variable representing the known shipment-volume of a product for each predetermined time range (for example, one or six hours) on the basis of data stored in the shipment table of the learning database 300. Examples of the target variable may include the sales-volume of one product in one store for each predetermined time range, the sales-volume of one product in all stores for each predetermined time range, and the sales proceeds of all products in one store for each predetermined time range. The data input device 101 further generates at least one explanatory variable that is information expected to influence target variables, for each target variable on the basis of the data stored in, for example, the meteorological table, client table, store attribute table, date-and-time attribute table, and product attribute table of the learning database 300. The data input device 101 then receives, as the input data 111, a plurality of combinations of target variables and explanatory variables. The data input device 101 receives parameters required for model estimation, such as the type of observation probability and candidates for the number of components, simultaneously with receiving the input data 111. In this exemplary embodiment, the data input device 101 exemplifies a learning data input unit.

The hierarchical latent structure setting unit 102 selects and sets the structure of a hierarchical latent variable model as a candidate for optimization, from the input types of observation probability and the input candidates for the number of components. The latent structure used in this exemplary embodiment is a tree structure. Letting C be the set number of components. Let equations used for the following description be equations for a hierarchical latent variable model of depth 2. The hierarchical latent structure setting unit 102 may store the selected structure of a hierarchical latent variable model in an internal memory.

Assuming, for example, that a binary tree model (a model having a bifurcation at each branch node) is used and the depth of tree structure is 2, the hierarchical latent structure setting unit 102 selects a hierarchical latent structure having two nodes at the first level and four nodes at the second level (in this exemplary embodiment, the nodes at the lowest level).

The initialization unit 103 performs an initialization process for estimating a hierarchical latent variable model. The initialization unit 103 can perform the initialization process by an arbitrary method. The initialization unit 103 may, for example, randomly set the type of observation probability for each component and, in turn, randomly set a parameter for each observation probability in accordance with the set type. The initialization unit 103 may further randomly set a lowest-level path variational probability for the hierarchical latent variable.

The hierarchical latent variable variational probability computation unit 104 computes the path latent variable variational probability for each hierarchical level. The parameter θ is computed by the initialization unit 103 or the component optimization unit 105 and the gating function optimization unit 106. Therefore, the hierarchical latent variable variational probability computation unit 104 computes the variational probability on the basis of the obtained value.

The hierarchical latent variable variational probability computation unit 104 obtains a Laplace approximation of the marginal log-likelihood function with respect to an estimation (for example, a maximum likelihood estimate or a maximum a posteriori probability estimate) for the complete variable and maximizes its lower bound to compute the variational probability. The thus computed variational probability will be referred to as an optimization criterion A hereinafter.

The procedure of computing the optimization criterion A will be described by taking a hierarchical latent variable model of depth 2 as an example. The marginal log-likelihood function is given by:

$$log p ( {x}^{N} \vert M ) \geq {\sum }_{{Z}^{N}} q ( {z}^{N} ) log \{ \frac{p ( {x}^{N} , {z}^{N} \vert M )}{q ( {z}^{N} )} \} \qquad ( Eqn . 2 )$$

where log represents, for example, a natural logarithm. In place of a natural logarithm, a logarithm having a value other than a Napier's value as its base is also applicable. The same applies to equations to be presented hereinafter.

The lower bound of the marginal log-likelihood function presented in Eqn. 2 will be considered first. In Eqn. 2, the equality holds true when the lowest-level path latent variable variational probability q(zⁿ) is maximized. Deriving a Laplace approximation of the marginal likelihood of the complete variable of the numerator in accordance with a maximum likelihood estimate for the complete variable yields an approximate expression of the marginal log-likelihood function given by:

$$( Eqn . 3 )$$

$$J ( q , \overline{θ} , {x}^{N} ) = {\sum }_{{z}^{N}} q ( {z}^{N} ) \{ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} log ( {\sum }_{n = 1}^{N} {\sum }_{j = 1}^{{K}_{2}} {z}_{ij}^{n} ) - {\sum }_{i = 1}^{{K}_{1}} {\sum }_{j = 1}^{{K}_{2}} \frac{{D}_{{φ}_{ij}}}{2} log ( {\sum }_{n = 1}^{N} {z}_{ij}^{n} ) - log q ( {z}^{N} ) \}$$

In Eqn. 3, the bar put over the letter symbolizes the maximum likelihood estimate for the complete variable, and D* is the dimension of the subscript parameter *.

Using the facts that the maximum likelihood estimate has the property of maximizing the marginal log-likelihood function and that the logarithmic function is expressed as a concave function, the lower bound presented in Eqn. 3 is calculated as Eqn. 4 represented as follows.

$$( Eqn . 4 )$$

$$g ( q , {q}^{′} , {q}^{″} , θ , {x}^{N} ) = {\sum }_{{Z}^{N}} q ( {z}^{N} ) [ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} \{ log ( {\sum }_{n = 1}^{N} {q}^{′} ( {z}_{i}^{n} ) ) + \frac{{\sum }_{n = 1}^{N} {\sum }_{j = 1}^{{K}_{2}} {z}_{ij}^{n}}{{\sum }_{n = 1}^{N} {q}^{′} ( {z}_{i}^{n} )} - 1 \} - {\sum }_{i = 1}^{{K}_{1}} {\sum }_{j = 1}^{{K}_{2}} \frac{{D}_{{φ}_{ij}}}{2} \{ log ( {\sum }_{n = 1}^{N} {q}^{″} ( {z}_{ij}^{n} ) ) + \frac{{\sum }_{n = 1}^{N} {z}_{ij}^{n}}{{\sum }_{n = 1}^{N} {q}^{″} ( {z}_{ij}^{n} )} - 1 \} - log q ( {z}^{N} ) ]$$

The variational distribution q′ of the first-level branch latent variable and the variational distribution q″ of the lowest-level path latent variable are calculated by maximizing Eqn. 4 for the respective variational distributions. Note that q″=q^{{t-1}} and θ=θ^{{t-1}} are fixed and q′ is fixed to a value given by Eqn. A.

$${q}^{′} = {\sum }_{j = 1}^{{K}_{2}} {q}^{\{ t - 1 \}} \qquad ( Eqn . A )$$

Note that the superscript (t) represents the t-th iteration in iterative computation of the hierarchical latent variable variational probability computation unit 104, the component optimization unit 105, the gating function optimization unit 106, and the optimality determination unit 107.

An exemplary operation of the hierarchical latent variable variational probability computation unit 104 will be described below with reference to FIG. 4.

The lowest-level path latent variable variational probability computation unit 104-1 receives the input data 111 and the estimated model 104-5 and computes the lowest-level latent variable variational probability q(z^{N}). The hierarchical setting unit 104-2 sets the lowest level for which the variational probability is to be computed. More specifically, the lowest-level path latent variable variational probability computation unit 104-1 computes the variational probability of each estimated model 104-5 for each combination of a target variable and an explanatory variable in the input data 111. The value of the variational probability is computed by a comparison between a solution obtained by substituting the explanatory variable in the input data 111 into the estimated model 104-5 and the target variable of the input data 111.

The higher-level path latent variable variational probability computation unit 104-3 computes the path latent variable variational probability for immediately higher level. More specifically, the higher-level path latent variable variational probability computation unit 104-3 computes the sum of latent variable variational probabilities of the current level having the same branch node as a parent and sets the obtained sum as the path latent variable variational probability for immediately higher level.

The hierarchical computation end determination unit 104-4 determines whether any higher level for which the variational probability is to be computed remains. If it is determined that any higher level is present, the hierarchical setting unit 104-2 sets immediately higher level for which the variational probability is to be computed. Subsequently, the higher-level path latent variable variational probability computation unit 104-3 and the hierarchical computation end determination unit 104-4 repeat the above-mentioned processes. If it is determined that any higher level is absent, the hierarchical computation end determination unit 104-4 determines that path latent variable variational probabilities have been computed for all levels.

The component optimization unit 105 optimizes the model of each component (the parameter θ and its type S) for Eqn. 4 and outputs the optimized, estimated model 104-5. In the case of a hierarchical latent variable model of depth 2, the component optimization unit 105 fixes q and q″ to the variational probability q^{t} of the lowest-level path latent variable computed by the hierarchical latent variable variational probability computation unit 104. The component optimization unit 105 further fixes q′ to the higher-level path latent variable variational probability presented in Eqn. A. The component optimization unit 105 then computes a model for maximizing the value of G presented in Eqn. 4.

G defined by Eqn. 4 allows decomposition of an optimization function for each component. It is, therefore, possible to independently optimize S₁ to S_{K1·K2} and the parameters φ₁ to Φ_{K1·K2} with no concern for a combination of types of components (for example, designation of any of S₁ to S_{K1·K2}). In this process, importance is placed on enabling such optimization. This makes it possible to optimize the type of component while avoiding combinatorial explosion.

An exemplary operation of the gating function optimization unit 106 will be described below with reference to FIG. 5. The branch node information acquisition unit 106-1 extracts a list of branch nodes using the estimated model 104-5 in the component optimization unit 105. The branch node selection unit 106-2 selects one branch node from the extracted list of branch nodes. The selected node will sometimes be referred to as a “selection node” hereinafter.

The branch parameter optimization unit 106-3 optimizes the branch parameter of the selection node on the basis of the input data 111 and the latent variable variational probability for the selection node obtained from the hierarchical latent variable variational probability 104-6. The branch parameter of the selection node is in the above-mentioned gating function.

The total branch node optimization end determination unit 106-4 determines whether all branch nodes extracted by the branch node information acquisition unit 106-1 have been optimized. If all branch nodes have been optimized, the gating function optimization unit 106 ends the process in this sequence. If all branch nodes have not been optimized, a process is performed by the branch node selection unit 106-2 and subsequent processes are performed by the branch parameter optimization unit 106-3 and the total branch node optimization end determination unit 106-4.

The gating function will be described hereinafter by taking, as a specific example, a gating function based on the Bernoulli distribution for a binary tree hierarchical model. A gating function based on the Bernoulli distribution will sometimes be referred to as a “Bernoulli gating function” hereinafter. Let x_{d} be the d-th dimension of x, g− be the probability of a branch of the binary tree to the lower left when this value is equal to or smaller than a threshold w, and g+ be the probability of a branch of the binary tree to the lower left when this value is larger than the threshold w. The branch parameter optimization unit 106-3 optimizes the above-mentioned optimization parameters d, w, g−, and g+ based on the Bernoulli distribution. This enables more rapid optimization because each parameter has an analytic solution, differently from the gating function based on the log it function described in NPL 2.

The optimality determination unit 107 determines whether the optimization criterion A computed using Eqn. 4 has converged. If the optimization criterion A has not converged, the processes by the hierarchical latent variable variational probability computation unit 104, the component optimization unit 105, the gating function optimization unit 106, and the optimality determination unit 107 are repeated. The optimality determination unit 107 may determine that the optimization criterion A has converged when, for example, the increment of the optimization criterion A is smaller than a predetermined threshold.

The processes by the hierarchical latent variable variational probability computation unit 104, the component optimization unit 105, the gating function optimization unit 106, and the optimality determination unit 107 will sometimes simply be referred to hereinafter as the processes by the hierarchical latent variable variational probability computation unit 104 through the optimality determination unit 107. An appropriate model can be selected by repeating the processes by the hierarchical latent variable variational probability computation unit 104 through the optimality determination unit 107 and updating the variational distribution and the model. Repeating these processes ensures monotone increasing of the optimization criterion A.

The optimal model selection unit 108 selects an optimal model. Assume, for example, that the optimization criterion A computed using the processes by the hierarchical latent variable variational probability computation unit 104 through the optimality determination unit 107 is larger than the currently set optimization criterion A, for the number C of hidden states set by the hierarchical latent structure setting unit 102. Then, the optimal model selection unit 108 selects the model as an optimal model.

The model estimation result output device 109 optimizes the model with regard to candidates for the structure of a hierarchical latent variable model set from the input type of observation probability and the input candidates for the number of components. If the optimization is complete, the model estimation result output device 109 outputs, for example, the number of optimal hidden states, the type of observation probability, the parameter, and the variational distribution as a model estimation result 112. If any candidate remains to be optimized, the hierarchical latent structure setting unit 102 performs the above-mentioned processes.

The central processing unit (to be abbreviated as the “CPU” hereinafter) of a computer operating in accordance with a program (hierarchical latent variable model estimation program) implements the following respective units:
the hierarchical latent structure setting unit 102;
the initialization unit 103;
the hierarchical latent variable variational probability computation unit 104 (more specifically, the lowest-level path latent variable variational probability computation unit 104-1, the hierarchical setting unit 104-2, the higher-level path latent variable variational probability computation unit 104-3, and the hierarchical computation end determination unit 104-4);
the component optimization unit 105;
the gating function optimization unit 106 (more specifically, the branch node information acquisition unit 106-1, the branch node selection unit 106-2, the branch parameter optimization unit 106-3, and the total branch node optimization end determination unit 106-4);
the optimality determination unit 107; and
the optimal model selection unit 108.

For example, the program is stored in a storage unit (not illustrated) of the hierarchical latent variable model estimation device 100, and the CPU reads this program and executes the processes in accordance with this program, in the following respective units:
the hierarchical latent structure setting unit 102;
the initialization unit 103;
the hierarchical latent variable variational probability computation unit 104 (more specifically, the lowest-level path latent variable variational probability computation unit 104-1, the hierarchical setting unit 104-2, the higher-level path latent variable variational probability computation unit 104-3, and the hierarchical computation end determination unit 104-4);
the component optimization unit 105;
the gating function optimization unit 106 (more specifically, the branch node information acquisition unit 106-1, the branch node selection unit 106-2, the branch parameter optimization unit 106-3, and the total branch node optimization end determination unit 106-4);
the optimality determination unit 107; and
the optimal model selection unit 108.

Dedicated hardware may be used to implement the following respective units:
the hierarchical latent structure setting unit 102;
the initialization unit 103;
the hierarchical latent variable variational probability computation unit 104;
the component optimization unit 105;
the gating function optimization unit 106;
the optimality determination unit 107; and
the optimal model selection unit 108.

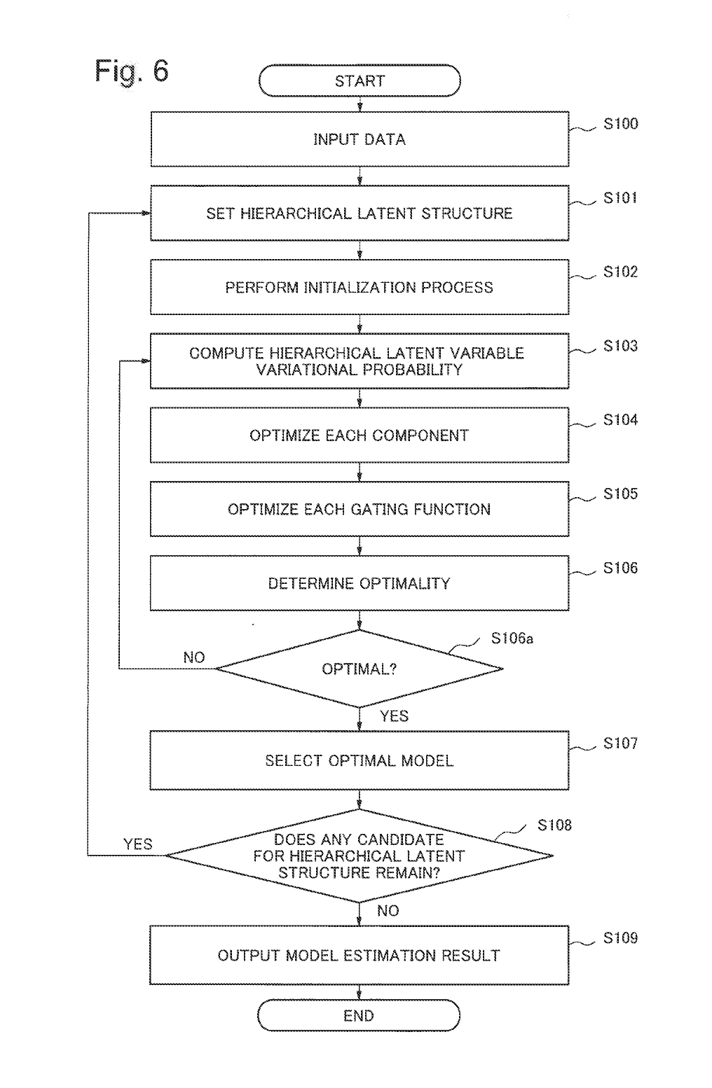

An exemplary operation of the hierarchical latent variable model estimation device according to this exemplary embodiment will be described below. FIG. 6 is a flowchart illustrating an exemplary operation of the hierarchical latent variable model estimation device according to at least one exemplary embodiment.

The data input device 101 receives input data 111 first (step S100). The hierarchical latent structure setting unit 102 then selects and sets a hierarchical latent structure remaining to be optimized in the input candidate values of the hierarchical latent structure (step S101). The initialization unit 103 initializes the latent variable variational probability and the parameter used for estimation, for the set hierarchical latent structure (step S102).

The hierarchical latent variable variational probability computation unit 104 computes each path latent variable variational probability (step S103). The component optimization unit 105 estimates the type of observation probability and the parameter for each component to optimize the components (step S104).

The gating function optimization unit 106 optimizes the branch parameter of each branch node (step S105). The optimality determination unit 107 determines whether the optimization criterion A has converged or not (step S106). In other words, the optimality determination unit 107 determines the model optimality.

If it is determined in step S106 that the optimization criterion A has not converged, that is, the model is not optimal (NO in step S106a), the processes in steps S103 to S106 are repeated.

If it is determined in step S106 that the optimization criterion A has converted, that is, the model is optimal (YES in step S106a), the optimal model selection unit 108 performs the following process. In other words, the optimal model selection unit 108 compares the optimization criterion A obtained based on the currently set optimal model (for example, the number of components, the type of observation probability, and the parameter) and the value of the optimization criterion A obtained based on the model currently set as an optimal model. The optimal model selection unit 108 selects a model having a larger value as an optimal model (step S107).

The optimal model selection unit 108 determines whether any candidate for the hierarchical latent structure remains to be estimated or not (step S108). If any candidate remains (YES in step S108), the processes in steps S102 to S108 are repeated. If no candidate remains (NO in step S108), the model estimation result output device 109 outputs a model estimation result 112 and ends the process (step S109). The model estimation result output device 109 stores the component optimized by the component optimization unit 105 and the gating function optimized by the gating function optimization unit 106 into the model database 500.

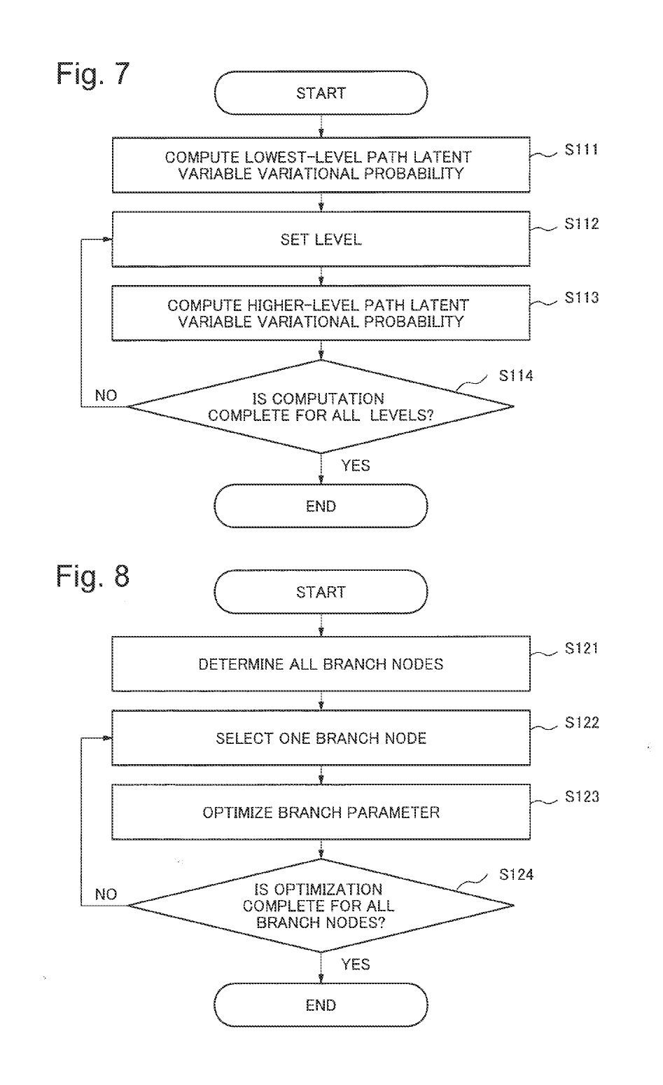

An exemplary operation of the hierarchical latent variable variational probability computation unit 104 according to this exemplary embodiment will be described below. FIG. 7 is a flowchart illustrating an exemplary operation of the hierarchical latent variable variational probability computation unit 104 according to at least one exemplary embodiment.

The lowest-level path latent variable variational probability computation unit 104-1 computes the lowest-level path latent variable variational probability (step S111). The hierarchical setting unit 104-2 sets the latest level for which the path latent variable has been computed (step S112). The higher-level path latent variable variational probability computation unit 104-3 computes the path latent variable variational probability for immediately higher level on the basis of the path latent variable variational probability for the level set by the hierarchical setting unit 104-2 (step S113).

The hierarchical computation end determination unit 104-4 determines whether path latent variables have been computed for all levels (step S114). If any level for which the path latent variable is to be computed remains (NO in step S114), the processes in steps S112 and S113 are repeated. If path latent variables have been computed for all levels, the hierarchical latent variable variational probability computation unit 104 ends the process.

An exemplary operation of the gating function optimization unit 106 according to this exemplary embodiment will be described below. FIG. 8 is a flowchart illustrating an exemplary operation of the gating function optimization unit 106 according to at least one exemplary embodiment.

The branch node information acquisition unit 106-1 determines all branch nodes (step S121). The branch node selection unit 106-2 selects one branch node to be optimized (step S122). The branch parameter optimization unit 106-3 optimizes the branch parameter of the selected branch node (step S123).

The total branch node optimization end determination unit 106-4 determines whether any branch node remains to be optimized (step S124). If any branch node remains to be optimized, the processes in steps S122 and S123 are repeated. If no branch node remains to be optimized, the gating function optimization unit 106 ends the process.

As described above, according to this exemplary embodiment, the hierarchical latent structure setting unit 102 sets a hierarchical latent structure. In the hierarchical latent structure, latent variables are represented by a hierarchical structure (tree structure) and components representing probability models are assigned to the nodes at the lowest level of the hierarchical structure.

The hierarchical latent variable variational probability computation unit 104 computes the path latent variable variational probability (that is, the optimization criterion A). The hierarchical latent variable variational probability computation unit 104 may compute the latent variable variational probabilities in turn from the nodes at the lowest level, for each level of the hierarchical structure. Further, the hierarchical latent variable variational probability computation unit 104 may compute the variational probability so as to maximize the marginal log-likelihood.

The component optimization unit 105 optimizes the component for the computed variational probability. The gating function optimization unit 106 optimizes the gating function on the basis of the latent variable variational probability at the node of the hierarchical latent structure. The gating function serves as a model for determining a branch direction in accordance with the multivariate data (for example, the explanatory variable) at the node of the hierarchical latent structure.

Since a hierarchical latent variable model for multivariate data is estimated using the above-mentioned configuration, a hierarchical latent variable model including hierarchical latent variables can be estimated with an adequate amount of computation without losing theoretical justification. Further, the use of the hierarchical latent variable model estimation device 100 obviates the need to manually set a criterion appropriate to select components.

The hierarchical latent structure setting unit 102 sets a hierarchical latent structure having latent variables represented in, for example, a binary tree structure. The gating function optimization unit 106 may optimize the gating function based on the Bernoulli distribution, on the basis of the latent variable variational probability at the node. This enables more rapid optimization because each parameter has an analytic solution.

With these processes, the hierarchical latent variable model estimation device 100 can determine optimal components for such patterns as a pattern defining better sales expected at relatively low or high air temperatures, a pattern defining better sales expected in the morning or the afternoon, and a pattern defining better sales expected at the weekend or the beginning of the next week.

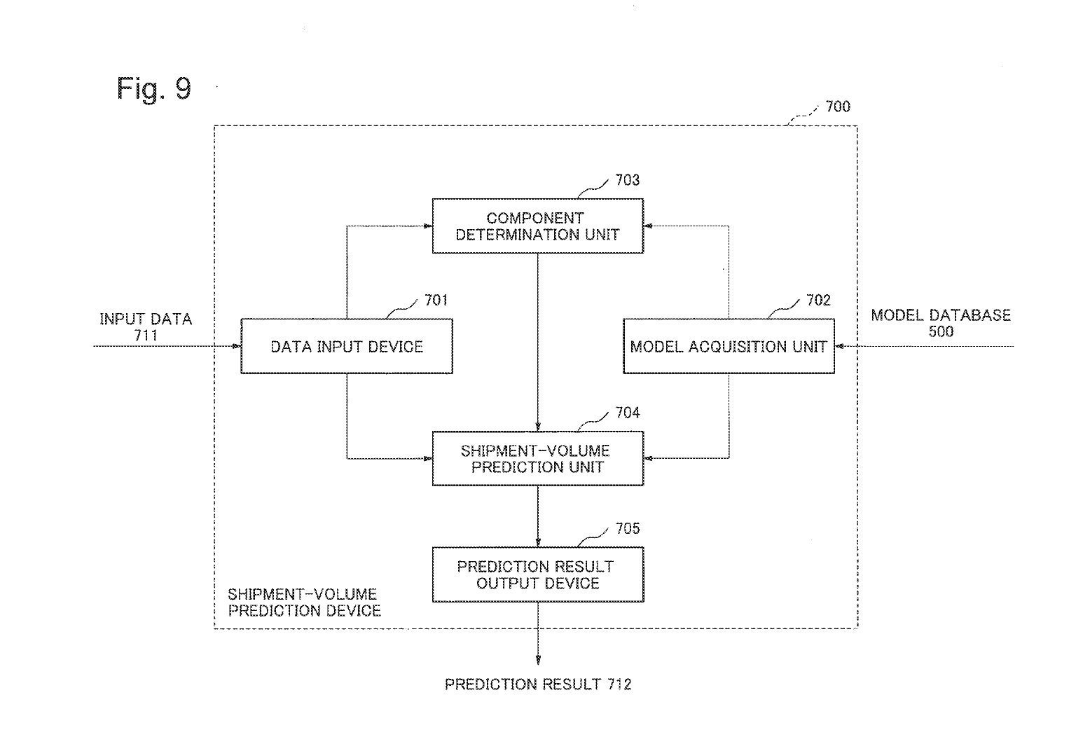

The shipment-volume prediction device according to this exemplary embodiment will be described below. FIG. 9 is a block diagram illustrating an exemplary configuration of the shipment-volume prediction device according to at least one exemplary embodiment.

The shipment-volume prediction device 700 includes a data input device 701, a model acquisition unit 702, a component determination unit 703, a shipment-volume prediction unit 704, and a output device 705 of a result of prediction (a prediction result output device 705).

The data input device 701 receives, as input data 711 (that is, prediction information), at least one explanatory variable that is information expected to influence the shipment-volume. The input data 711 is formed by the same types of explanatory variables as those forming the input data 111. In this exemplary embodiment, the data input device 701 exemplifies a prediction data input unit.

The model acquisition unit 702 acquires a gating function and a component from the model database 500 as a prediction model for the shipment-volume. The gating function is optimized by the gating function optimization unit 106. The component is optimized by the component optimization unit 105.

The component determination unit 703 traces the hierarchical latent structure on the basis of the input data 711 input to the data input device 701 and the gating function acquired by the model acquisition unit 702. The component determination unit 703 selects a component associated with the node at the lowest level of the hierarchical latent structure as a component for predicting the shipment-volume.

The shipment-volume prediction unit 704 predicts the shipment-volume by substituting the input data 711 input to the data input device 701 into the component selected by the component determination unit 703.

The prediction result output device 705 outputs a prediction result 712 for the shipment-volume predicted by the shipment-volume prediction unit 704.

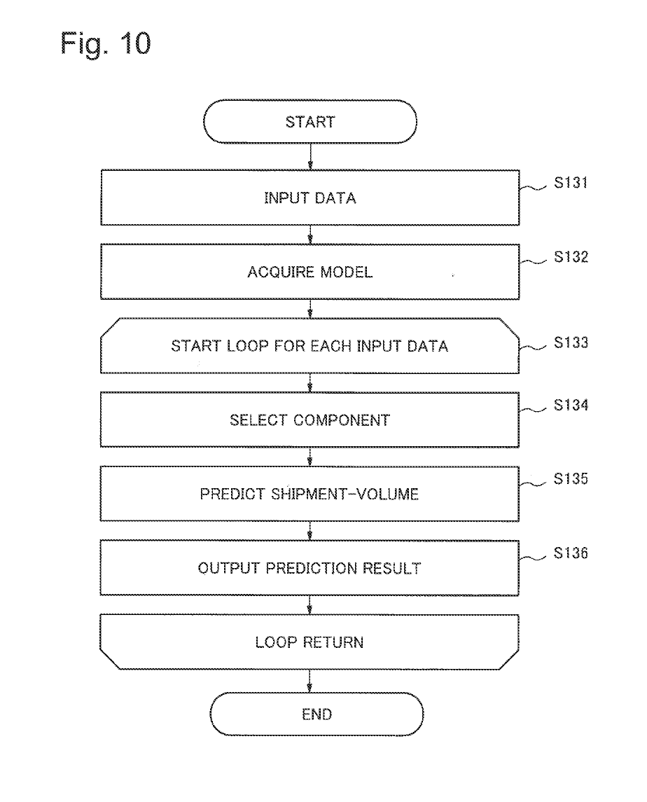

An exemplary operation of the shipment-volume prediction device according to this exemplary embodiment will be described below. FIG. 10 is a flowchart illustrating an exemplary operation of the shipment-volume prediction device according to at least one exemplary embodiment.

The data input device 701 receives input data 711 first (step S131). The data input device 701 may receive a plurality of input data 711 instead of only one input data 711. For example, the data input device 701 may receive input data 711 for each time of day (timing) on a certain date in a certain store. When the data input device 701 receives a plurality of input data 711, the shipment-volume prediction unit 704 predicts the shipment-volume for each input data 711. The model acquisition unit 702 acquires a gating function and a component from the model database 500 (step S132).

The shipment-volume prediction device 700 selects the input data 711 one by one and performs the following processes in steps S134 to S136 for the selected input data 711 (step S133).

The component determination unit 703 first selects a component used to predict the shipment-volume by tracing the path from the root node to the node at the lowest level in the hierarchical latent structure in accordance with the gating function acquired by the model acquisition unit 702 (step S134). More specifically, the component determination unit 703 selects a component in accordance with the following procedure.

The component determination unit 703 reads, for each node of the hierarchical latent structure, a gating function associated with this node. The component determination unit 703 determines whether the input data 711 satisfies the read gating function. The component determination unit 703 determines the node to be traced next in accordance with the determination result. Upon reaching the node at the lowest level through the nodes of the hierarchical latent structure by this process, the component determination unit 703 selects a component associated with this node as a component for prediction of the shipment-volume.

When the component determination unit 703 selects a component used to predict the shipment-volume in step S134, the shipment-volume prediction unit 704 predicts the shipment-volume by substituting the input data 711 selected in step S133 into the component (step S135). The prediction result output device 705 outputs a prediction result 712 for the shipment-volume obtained by the shipment-volume prediction unit 704 (step S136).

The shipment-volume prediction device 700 performs the processes in steps S134 to S136 for all input data 711 and ends the process.

As described above, according to this exemplary embodiment, the shipment-volume prediction device 700 can accurately predict the shipment-volume using an appropriate component on the basis of the gating function. In particular, since the gating function and the component are estimated by the hierarchical latent variable model estimation device 100 without losing theoretical justification, the shipment-volume prediction device 700 can predict the shipment-volume using components selected in accordance with an appropriate criterion.

### Second Exemplary Embodiment

A second exemplary embodiment of a shipment-volume prediction system will be described next. The shipment-volume prediction system according to this exemplary embodiment is different from the shipment-volume prediction system 10 in that in the former, the hierarchical latent variable model estimation device 100 is replaced with an estimation device 200 of a hierarchical latent variable model (a hierarchical latent variable model estimation device 200).

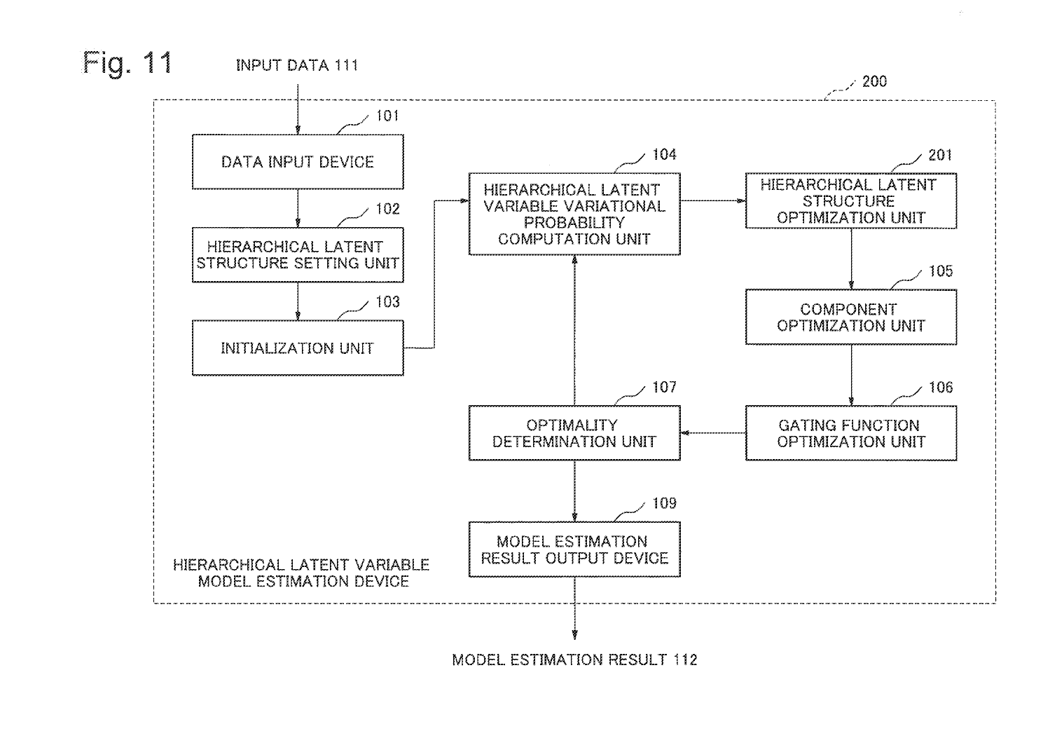

FIG. 11 is a block diagram illustrating an exemplary configuration of a hierarchical latent variable model estimation device according to at least one exemplary embodiment. The same reference numerals as in FIG. 3 denote the same configurations as in the first exemplary embodiment, and a description thereof will not be given. The hierarchical latent variable model estimation device 200 according to this exemplary embodiment is different from the hierarchical latent variable model estimation device 100 in that an optimization unit 201 of a hierarchical latent structure (a hierarchical latent structure optimization unit 201) is connected to the former while the optimal model selection unit 108 is not connected to the former.

In the first exemplary embodiment, the hierarchical latent variable model estimation device 100 optimizes the model of the component and the gating function with regard to candidates for the hierarchical latent structure to select a hierarchical latent structure which maximizes the optimization criterion A. On the other hand, with the hierarchical latent variable model estimation device 200 according to this exemplary embodiment, a process for removing, by the hierarchical latent structure optimization unit 201, a path having its latent variable reduced from the model is added to the subsequent stage of the process by a hierarchical latent variable variational probability computation unit 104.

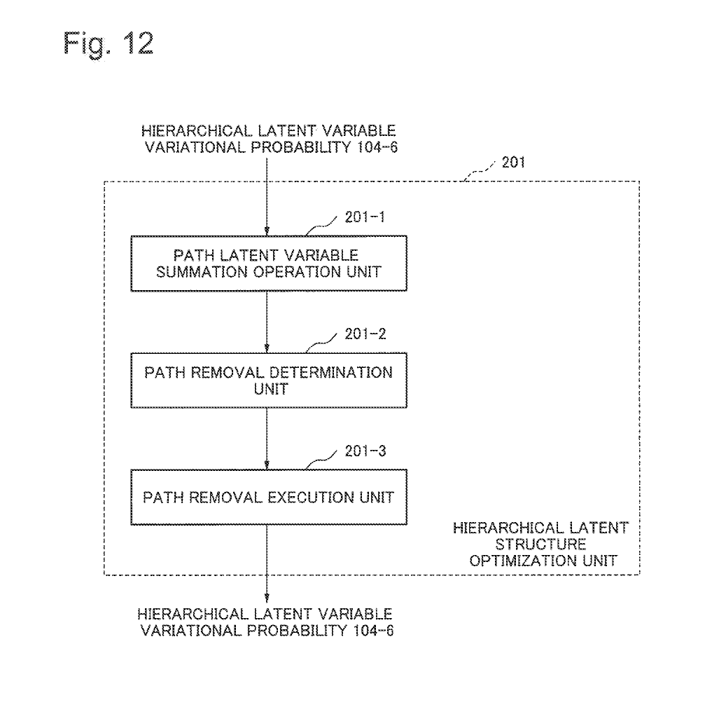

FIG. 12 is a block diagram illustrating an exemplary configuration of the hierarchical latent structure optimization unit 201 according to at least one exemplary embodiment. The hierarchical latent structure optimization unit 201 includes a summation operation unit 201-1 of a path latent variable (a path latent variable summation operation unit 201-1), a determination unit 201-2 of path removal (a path removal determination unit 201-2), and a removal execution unit 201-3 of a path (a path removal execution unit 201-3).

The path latent variable summation operation unit 201-1 receives a hierarchical latent variable variational probability 104-6 and computes the sum (to be referred to as the “sample sum” hereinafter) of lowest-level path latent variable variational probabilities in each component.

The path removal determination unit 201-2 determines whether the sample sum is equal to or smaller than a predetermined threshold E. The threshold c is input together with input data 111. More specifically, a condition determined by the path removal determination unit 201-2 can be expressed as, for example:

$${\sum }_{n = 1}^{N} q ( {z}_{ij}^{n} ) \leq ɛ \qquad ( Eqn . 5 )$$

More specifically, the path removal determination unit 201-2 determines whether the lowest-level path latent variable variational probability q(zᵢⱼⁿ) in each component satisfies the criterion presented in Eqn. 5. In other words, the path removal determination unit 201-2 determines whether the sample sum is sufficiently small.

The path removal execution unit 201-3 sets the variational probability of a path determined to have a sufficiently small sample sum to zero. The path removal execution unit 201-3 recomputes and outputs a hierarchical latent variable variational probability 104-6 at each hierarchical level on the basis of the lowest-level path latent variable variational probability normalized for the remaining paths (that is, paths whose variational probability is not set to be 0).

The justification of this process will be described below. An exemplary updated equation of q(zᵢⱼⁿ) in iterative optimization is given by:

$${q}^{t} ( {z}_{ij}^{n} ) ∝ {g}_{i}^{n} {g}_{j \vert i}^{n} p ( {x}^{n} \vert {φ}_{ij} ) exp \{ \frac{- {D}_{{β}_{i}}}{2 {\sum }_{n = 1}^{N} {\sum }_{j = 1}^{{K}_{2}} {q}^{t - 1} ( {z}_{ij}^{n} )} + \frac{- {D}_{{φ}_{ij}}}{2 {\sum }_{n = 1}^{N} {q}^{t - 1} ( {z}_{ij}^{n} )} \} \qquad ( Eqn . 6 )$$

In Eqn. 6, the exponential part includes a negative term and q(zᵢⱼⁿ) computed in the preceding process serves as the denominator of the term. Therefore, the smaller the value of this denominator, the smaller the value of optimized q(zᵢⱼⁿ), so that the variational probabilities of small path latent variables gradually reduce upon iterative computation.

The hierarchical latent structure optimization unit 201 (more specifically, the path latent variable summation operation unit 201-1, the path removal determination unit 201-2, and the path removal execution unit 201-3) is implemented by the CPU of a computer operating in accordance with a program (hierarchical latent variable model estimation program).

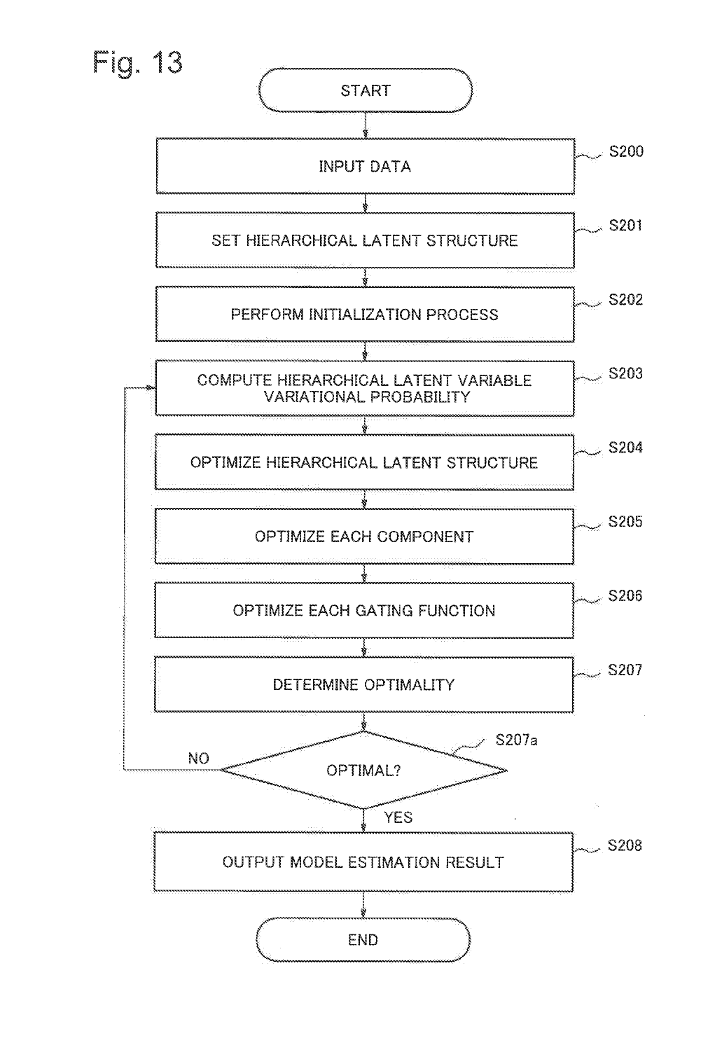

An exemplary operation of the hierarchical latent variable model estimation device 200 according to this exemplary embodiment will be described below. FIG. 13 is a flowchart illustrating an exemplary operation of the hierarchical latent variable model estimation device 200 according to at least one exemplary embodiment.

A data input device 101 receives input data 111 first (step S200). A hierarchical latent structure setting unit 102 sets the initial state of the number of hidden states as a hierarchical latent structure (step S201).

In the first exemplary embodiment, an optimal solution is searched by executing all of a plurality of candidates for the number of components. In the second exemplary embodiment, the hierarchical latent structure can be optimized by only one process because the number of components is also optimized. Thus, in step S201, the initial value of the number of hidden states need only be set once instead of selecting a candidate remaining to be optimized from a plurality of candidates, as in step S102 of the first exemplary embodiment.

An initialization unit 103 initializes the latent variable variational probability and the parameter used for estimation, for the set hierarchical latent structure (step S202).

The hierarchical latent variable variational probability computation unit 104 computes each path latent variable variational probability (step S203). The hierarchical latent structure optimization unit 201 estimates the number of components to optimize the hierarchical latent structure (step S204). In other words, because the components are assigned to the respective nodes at the lowest level, when the hierarchical latent structure is optimized, the number of components is also optimized.

A component optimization unit 105 estimates the type of observation probability and the parameter for each component to optimize the components (step S205). A gating function optimization unit 106 optimizes the branch parameter of each branch node (step S206). An optimality determination unit 107 determines whether the optimization criterion A has converged (step S207). In other words, the optimality determination unit 107 determines the model optimality.

If it is determined in step S207 that the optimization criterion A has not converged, that is, the model is not optimal (NO in step S207a), the processes in steps S203 to S207 are repeated.

If it is determined in step S106 that the optimization criterion A has converted, that is, the model is optimal (YES in step S207a), a model estimation result output device 109 outputs a model estimation result 112 and ends the process (step S208).

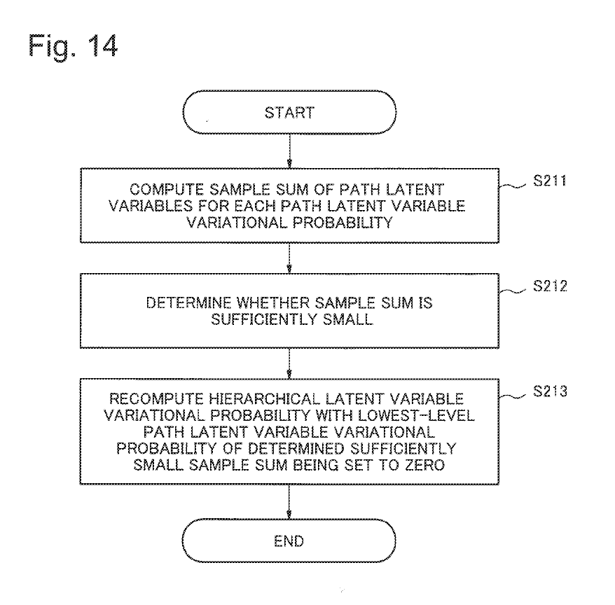

An exemplary operation of the hierarchical latent structure optimization unit 201 according to this exemplary embodiment will be described below. FIG. 14 is a flowchart illustrating an exemplary operation of the hierarchical latent structure optimization unit 201 according to at least one exemplary embodiment.

The path latent variable summation operation unit 201-1 computes the sample sum of path latent variables first (step S211). The path removal determination unit 201-2 determines whether the computed sample sum is sufficiently small (step S212). The path removal execution unit 201-3 outputs a hierarchical latent variable variational probability recomputed after the lowest-level path latent variable variational probability determined to yield a sufficiently small sample sum is set to zero, and ends the process (step S213).

As descried above, in this exemplary embodiment, the hierarchical latent structure optimization unit 201 optimizes the hierarchical latent structure by removing a path having a computed variational probability equal to or lower than a predetermined threshold from the model.

With such a configuration, in addition to the effects of the first exemplary embodiment, a plurality of candidates for the hierarchical latent structure need not be optimized, as in the hierarchical latent variable model estimation device 100, and the number of components can be optimized as well by only one execution process. Therefore, the computation costs can be kept low by estimating the number of components, the type of observation probability, the parameter, and the variational distribution at once.

### Third Exemplary Embodiment

A third exemplary embodiment of a shipment-volume prediction system will be described next. The shipment-volume prediction system according to this exemplary embodiment is different from that according to the second exemplary embodiment in terms of the configuration of the hierarchical latent variable model estimation device. The hierarchical latent variable model estimation device according to this exemplary embodiment is different from the hierarchical latent variable model estimation device 200 in that in the former, the gating function optimization unit 106 is replaced with a optimization unit 113 of a gating function (a gating function optimization unit 113).

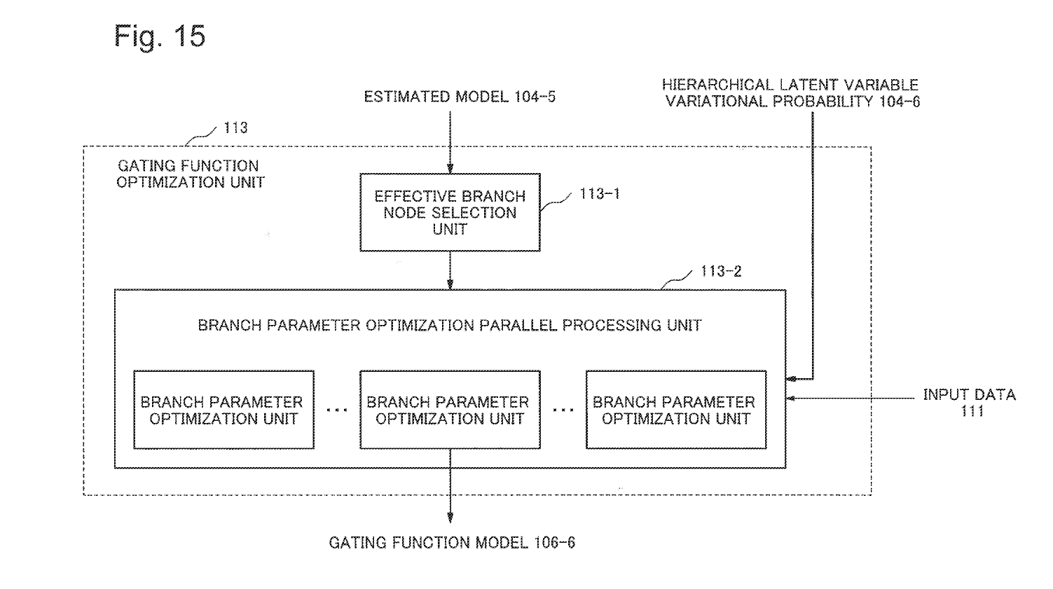

FIG. 15 is a block diagram illustrating an exemplary configuration of the gating function optimization unit 113 according to the third exemplary embodiment. The gating function optimization unit 113 includes a selection unit 113-1 of an effective branch node (an effective branch node selection unit 113-1) and a parallel processing unit 113-2 of optimization of a branch parameter (a branch parameter optimization parallel processing unit 113-2).

The effective branch node selection unit 113-1 selects an effective branch node from the hierarchical latent structure. More specifically, the effective branch node selection unit 113-1 selects an effective branch node in consideration of paths removed from the model through the use of an model 104-5 estimated by a component optimization unit 105. The effective branch node means herein a branch node on a path not removed from the hierarchical latent structure.

The branch parameter optimization parallel processing unit 113-2 performs processes for optimizing the branch parameters for effective branch nodes in parallel and outputs a gating function model 106-6. More specifically, the branch parameter optimization parallel processing unit 113-2 optimizes all branch parameters for all effective branch nodes, using input data 111 and a hierarchical latent variable variational probability 104-6 computed by a hierarchical latent variable variational probability computation unit 104.

The branch parameter optimization parallel processing unit 113-2 may be formed by, for example, arranging the branch parameter optimization units 106-3 according to the first exemplary embodiment in parallel, as illustrated in FIG. 15. Such a configuration allows optimization of the branch parameters for all gating functions at once.

In other words, the hierarchical latent variable model estimation devices 100 and 200 perform gating function optimization processes one by one. The hierarchical latent variable model estimation device according to this exemplary embodiment enables more rapid estimation of model because it can perform gating function optimization processes in parallel.

The gating function optimization unit 113 (more specifically, the effective branch node selection unit 113-1 and the branch parameter optimization parallel processing unit 113-2) is implemented by the CPU of a computer operating in accordance with a program (hierarchical latent variable model estimation program).

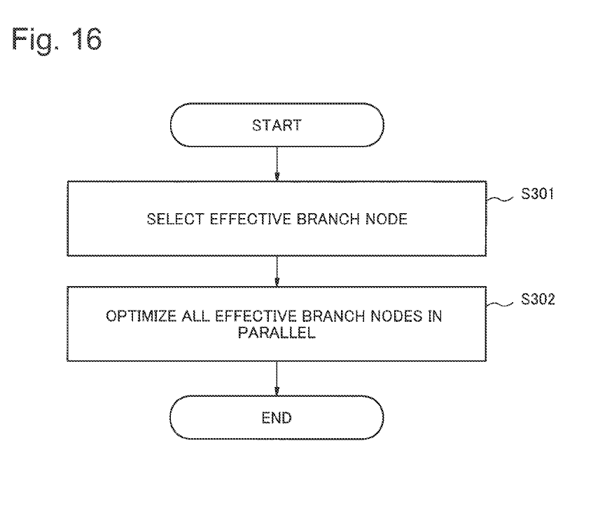

An exemplary operation of the gating function optimization unit 113 according to this exemplary embodiment will be described below. FIG. 16 is a flowchart illustrating an exemplary operation of the gating function optimization unit 113 according to at least one exemplary embodiment. The effective branch node selection unit 113-1 selects all effective branch nodes first (step S301). The branch parameter optimization parallel processing unit 113-2 optimizes all the effective branch nodes in parallel and ends the process (step S302).

As described above, according to this exemplary embodiment, the effective branch node selection unit 113-1 selects an effective branch node from the nodes of the hierarchical latent structure. The branch parameter optimization parallel processing unit 113-2 optimizes the gating function on the basis of the latent variable variational probability for the effective branch node. In doing this, the branch parameter optimization parallel processing unit 113-2 processes optimization of each branch parameter of the effective branch node in parallel. This enables parallel processes for optimizing the gating functions and thus enables more rapid estimation of model in addition to the effects of the aforementioned exemplary embodiments.

### Fourth Exemplary Embodiment

A fourth exemplary embodiment of the present invention will be described next.

A shipment-volume prediction system according to the fourth exemplary embodiment performs order management of a target store on the basis of the shipment-volume estimation of a product in the target store. More specifically, the shipment-volume prediction system determines an order-volume on the basis of the shipment-volume estimation of a product at the point of time when an order to the product is sent. The shipment-volume prediction system according to the fourth exemplary embodiment exemplifies an order-volume determination system.

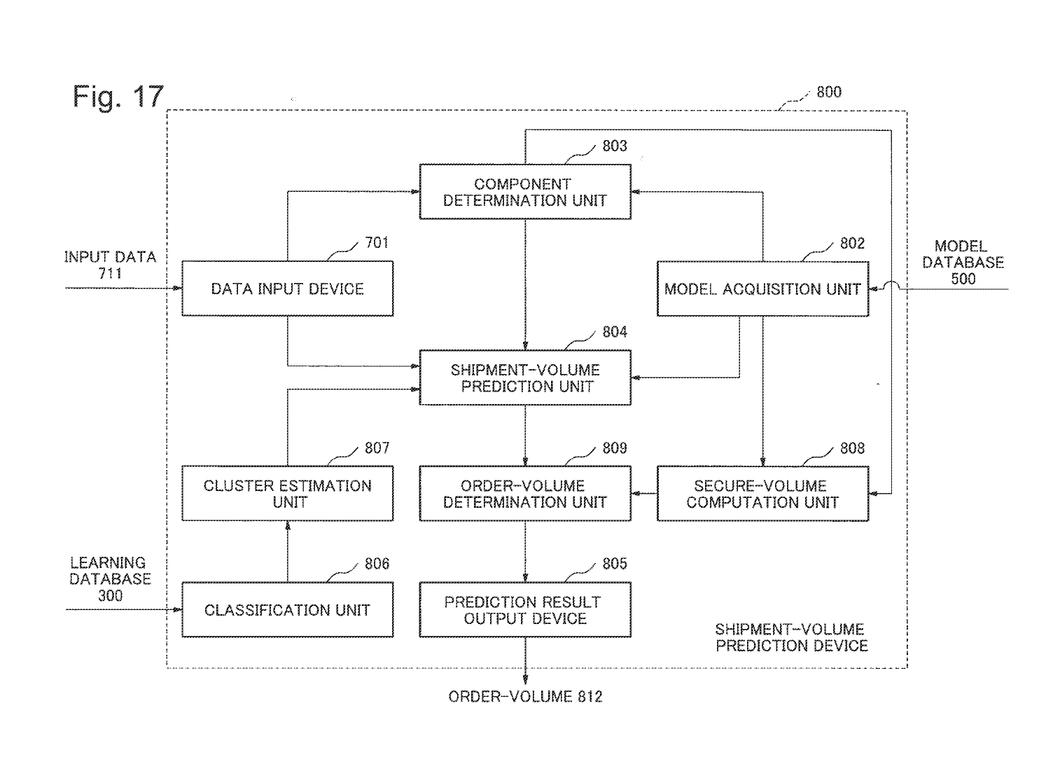

FIG. 17 is a block diagram illustrating an exemplary configuration of a shipment-volume prediction device according to at least one exemplary embodiment. In the shipment-volume prediction system according to this exemplary embodiment, compared to the shipment-volume prediction system 10, the shipment-volume prediction device 700 is replaced with a prediction device 800 of shipment-volume (a shipment-volume prediction device 800). The shipment-volume prediction device 800 exemplifies an order-volume prediction device.

The shipment-volume prediction device 800 includes a classification unit 806, a cluster estimation unit 807, a secure-volume calculation processing unit 808 (a secure-volume computation unit 808), and an order-volume determination unit 809 additionally to the configuration according to the first exemplary embodiment. The shipment-volume prediction device 800 is different from the first exemplary embodiment in terms of the operations of a model acquisition unit 802, a component determination unit 803, a prediction unit 804 of shipment-volume (a shipment-volume prediction unit 804), and a output device 805 of a result of prediction (a prediction result output device 805).

The classification unit 806 acquires the store attributes of a plurality of stores from a store attribute table in a learning database 300 and classifies the stores into clusters based on these store attributes. The classification unit 806 classifies the stores into clusters in accordance with, for example, the k-means algorithm and various types of hierarchical clustering algorithms. The k-means algorithm classifies respective individuals into randomly generated clusters and iteratively executes processes for updating the centers of each cluster based on the information of the classified individuals, thereby clustering the individuals.

The cluster estimation unit 807 estimates a cluster, to which a store serving as a target for prediction of the shipment-volume belongs, on the basis of the classification result obtained by the classification unit 806.

The secure-volume computation unit 808 computes the secure-volume of inventory on the basis of an estimation error of each component determined by the component determination unit 803. The secure-volume means herein, for example, an inventory that is less likely to run short.

The order-volume determination unit 809 determines an order-volume on the basis of the inventory of a product in the target store, the shipment-volume of the product predicted by the shipment-volume prediction unit 804, and the secure-volume computed by the secure-volume computation unit 808.

An exemplary operation of the shipment-volume prediction system according to this exemplary embodiment will be described below.

A hierarchical latent variable model estimation device 100 first estimates a gating function and a component which form the basis for predicting the shipment-volume of a product in a store during a time frame, for each store, each product, and each time frame. In this exemplary embodiment, the hierarchical latent variable model estimation device 100 estimates a gating function and a component during each time frame (that is, a time frame set every hour) obtained by dividing one day into 24 equal parts. In this exemplary embodiment, the hierarchical latent variable model estimation device 100 computes a gating function and a component in accordance with the method described in the first exemplary embodiment. In other exemplary embodiments, the hierarchical latent variable model estimation device 100 may compute a gating function and a component in accordance with the method described in the second or third exemplary embodiment.

In this exemplary embodiment, the hierarchical latent variable model estimation device 100 computes the prediction-error spread of each estimated component. Examples of the prediction-error spread may include the standard deviation, variance, and range of prediction-error and the standard deviation, variance, and range of prediction-error rate. The prediction-errors can be calculated as, for example, the difference between the value of the target variable computed based on an estimated model 104-5 (component) and that of the target variable referred to in generating a component (estimated model 104-5).

The hierarchical latent variable model estimation device 100 stores the estimated gating functions, the components, and the prediction-errors spread of these components into a model database 500.

When the estimated gating functions, the components, and the prediction-error spread of each component are stored in the model database 500, the shipment-volume prediction device 800 starts a process for predicting an order-volume.

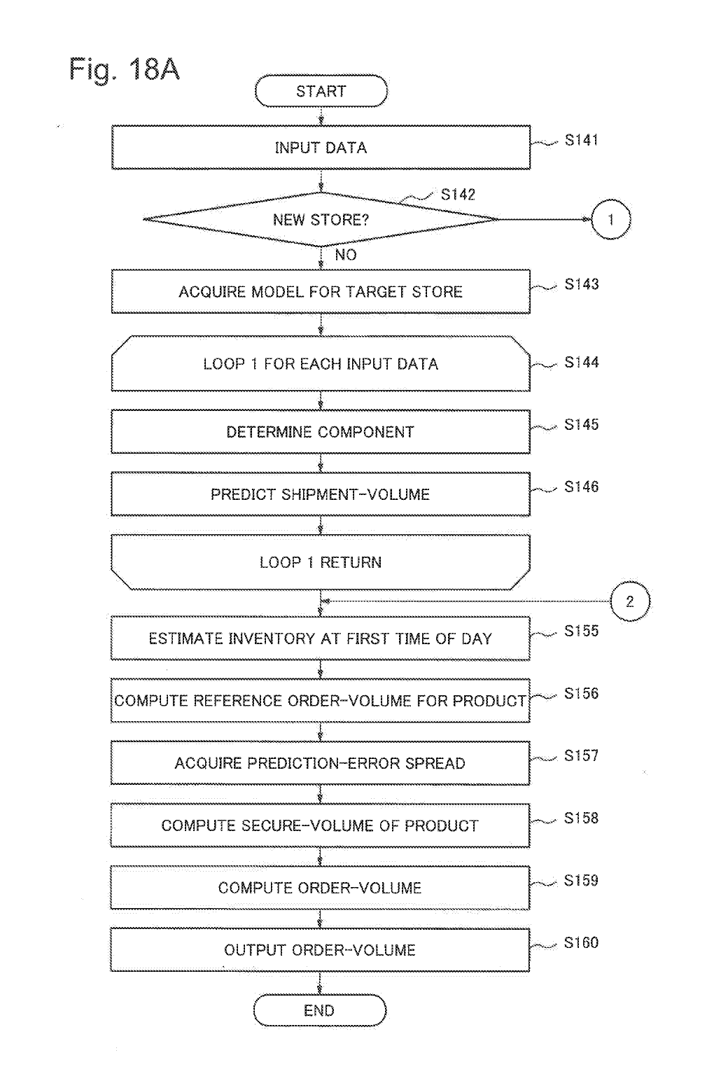

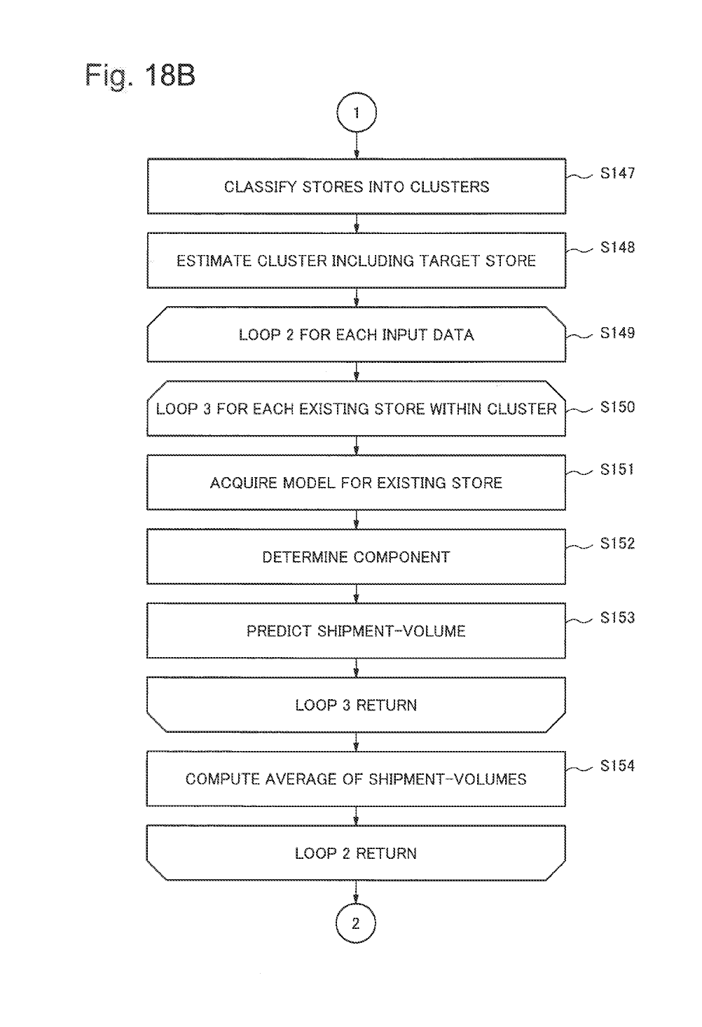

FIGS. 18A and 18B are flowcharts illustrating exemplary operations of the shipment-volume prediction device according to at least one exemplary embodiment.

A data input device 701 in the shipment-volume prediction device 800 receives input data 711 (step S141). More specifically, the data input device 701 receives, as input data 711, information such as the store attribute and date-and-time attribute of a target store, the product attribute of each product being dealt at the target store, and meteorological phenomena between the present time and the time when a product ordered next to the current order will be accepted by the target store. In this exemplary embodiment, the time when a currently ordered product will be accepted by the target store is defined as a “first time of day.” In other words, the first time of day is a future time. The time when a product ordered next to the current order will be accepted by the target store is defined as a “second time of day.” The data input device 701 receives the inventory at the present time in the target store and the acceptance-volume of a product during a period between the present time and the first time of day.

The model acquisition unit 802 determines whether the target store is a new one (step S142). The model acquisition unit 802 determines that the target store is a new one when, for example, no information concerning the gating functions, the components, and the prediction-errors spread for the target store is stored in the model database 500. The model acquisition unit 802 determines that the target store is a new one when, for example, no information associated with the store ID of the target store is found in a shipment table within the learning database 300.

If the model acquisition unit 802 determines that the target store is an existing one (NO in step S142), it acquires the gating functions, the components, and the prediction-errors spread for the target store from the model database 500 (step S143). The shipment-volume prediction device 800 selects input data 711 one by one and performs the processes in steps S145 and S146 (to be described below) for the selected input data 711 (step S144). In other words, the shipment-volume prediction device 800 performs the processes in steps S145 and S146 every hour between the present time and the second time of day for each product being dealt at the target store.

The component determination unit 803 first determines a component for predicting the shipment-volume by tracing the nodes from the root node to the node at the lowest level in the hierarchical latent structure in accordance with the gating functions acquired by the model acquisition unit 802 (step S145). The shipment-volume prediction unit 804 predicts the shipment-volume by setting the values of the input data 711 selected in step S144 to input of the components (step S146).

If the model acquisition unit 802 determines that the target store is a new one (YES in step S142), the classification unit 806 reads the store attributes of a plurality of stores from the store attribute table of the learning database 300. The classification unit 806 classifies the stores into clusters on the basis of the read store attributes (step S147). The classification unit 806 may classify the stores into clusters including the target store. The cluster estimation unit 807 estimates a specific cluster including the target store on the basis of the classification result obtained by the classification unit 806 (step S148).

The shipment-volume prediction device 800 selects the input data 711 one by one and performs the processes in steps S150 to S154 (to be described hereinafter) for the selected input data 711 (step S149).

The shipment-volume prediction device 800 selects, one by one, existing stores in the specific cluster and performs the processes in steps S151 to S153 (to be described hereinafter) for the selected existing stores (step S150).

The model acquisition unit 802 first reads, from the model database 500, the gating functions, the components, and the prediction-errors spread for the existing stores selected in step S150 (step S151). The component determination unit 803 determines a component for predicting the shipment-volume by tracing the nodes from the root node to the node at the lowest level in the hierarchical latent structure in accordance with the gating functions read by the model acquisition unit 802 (step S152). In other words, in this case, the component determination unit 803 selects a component by applying the gating function to the information in the input data 711. The shipment-volume prediction unit 804 predicts the shipment-volume by setting the values of the input data 711 selected in step S151 to input of the component (step S153).

In other words, the processes in steps S151 to S153 are performed for all existing stores in the cluster including the target store. Therefore, the shipment-volumes of products are predicted for existing stores in a specific cluster.

The shipment-volume prediction unit 804 computes, for each product, the average of the shipment-volumes in each store where the product in question is being dealt, as a predicted shipment-volume of this product in the target store (step S154). Thus, the shipment-volume prediction device 800 predicts the shipment-volume of a product even for a new store, that is, without accumulated past information of the shipment-volume for the new store.

When the shipment-volume prediction device 800 performs the processes in steps S145 and S146 or the processes in steps S149 to S154 for all input data 711, the order-volume determination unit 809 estimates the inventory of a product at the first time of day (step S155). More specifically, the order-volume determination unit 809 computes the sum of the inventory of a product at the present time in the target store input to the data input device 701 and the acceptance-volume of the product during the period between the present time and the first time of day. In accordance with the computed sum, the order-volume determination unit 809 estimates the inventory of the product at the first time of day by subtracting the sum total of the predicted shipment-volumes of the product, which is predicted by the shipment-volume prediction unit 804, during the period between the present time and the first time of day.

The order-volume determination unit 809 computes a reference order-volume of the product by adding the sum total of the predicted shipment-volumes of the product, which is predicted by the shipment-volume prediction unit 804, during the period between the first time of day and the second time of day to the estimated inventory of the product at the first time of day (step S156).

The secure-volume computation unit 808 reads the prediction-error spread of each component determined by the hierarchical latent variable model estimation device 100 in step S145 or S152 from the model acquisition unit 802 (step S157). The secure-volume computation unit 808 computes the secure-volume of the product on the basis of the acquired prediction-error spread (step S158). When the prediction-error spread is the standard deviation of prediction-error, the secure-volume computation unit 808 can compute the secure-volume by, for example, multiplying the sum total of the standard deviations by a predetermined coefficient. When the prediction-error spread is the standard deviation of prediction-error rate, the secure-volume computation unit 808 can compute the secure-volume by, for example, multiplying the sum total of the predicted shipment-volumes during a period between the first time of day and the second time of day by the average of the standard deviations and a predetermined coefficient.

The order-volume determination unit 809 determines an order-volume of the product by adding the secure-volume computed in step S158 to the reference order-volume computed in step S156 (step S159). A prediction result output device 705 outputs an order-volume 812 determined by the order-volume determination unit 809 (step S160). In this manner, the shipment-volume prediction device 800 can determine an appropriate order-volume by selecting an appropriate component on the basis of the gating functions.

As described above, according to this exemplary embodiment, the shipment-volume prediction device 800 can accurately predict the shipment-volume and determine an appropriate order-volume, regardless of whether the target store is a new one or an existing one. This is because the shipment-volume prediction device 800 selects an existing store similar (or identical) to the target store and determines a shipment-volume in accordance with, for example, the gating functions for the existing store.

This exemplary embodiment assumes that the shipment-volume prediction unit 804 predicts a shipment-volume in a new store on the basis of a component to predict the shipment-volume of an existing store during the period between the present time and the second time of day, but the present invention is not limited to this. For example, in other exemplary embodiments, the shipment-volume prediction unit 804 may predict a shipment-volume in a new store at the time of opening a new store on the basis of a component optimized with the sales data of a product in an existing store. In this case, the shipment-volume prediction unit 804 can more precisely predict a shipment-volume.

Furthermore, this exemplary embodiment assumes that when the shipment-volume prediction unit 804 predicts a target new store's shipment-volume, it computes the average of the predicted shipment-volumes of an existing store in the same cluster as the target new store, but the present invention is not limited to this. For example, in other exemplary embodiments, the shipment-volume prediction unit 804 may apply a weight indicating the degree of similarity between the target store and the existing store and may compute the weighted average in accordance with the weight. The shipment-volume prediction unit 804 may compute the shipment-volume using other representative values such as the median or maximum values.

Moreover, this exemplary embodiment assumes that when the target store is a new one, a shipment-volume is predicted on the basis of a model for an existing store, but the present invention is not limited to this. For example, in other exemplary embodiments, even when the target store is an existing one, the shipment-volume prediction unit 804 may predict a shipment-volume of a new product launched by this target store in accordance with a model for another existing store in the same cluster as this target store.

This exemplary embodiment assumes that the second time of day is the time when a product ordered next to the current order will be accepted by the target store, but the present invention is not limited to this. For example, in other exemplary embodiments, when a sell-by date (time) such as a best-before date or a use-by date (time) is set for a product, the shipment-volume prediction device 800 may determine an order-volume by setting the sell-by date (time) of a currently ordered product to the second time of day. Thus, the shipment-volume prediction device 800 can determine an order-volume so as not to cause inventory loss as the product has passed its sell-by date (time). In still other exemplary embodiments, the shipment-volume prediction device 800 may determine an order-volume by setting the earlier of the time in either the time when a product ordered next to the current order will be accepted by the target store or the sell-by date (time) of a currently ordered product to the second time of day.

This exemplary embodiment assumes that the shipment-volume prediction device 800 determines, as an order-volume, the sum of the reference order-volume and the secure-volume so as not to cause loss of sales opportunities, but the present invention is not limited to this. For example, in other exemplary embodiments, to prevent excess inventory, the shipment-volume prediction device 800 may determine, as an order-volume, the result of subtracting an amount based on the prediction-error spread from the reference order-volume.

### Fifth Exemplary Embodiment

A fifth exemplary embodiment of a shipment-volume prediction system will be described next.

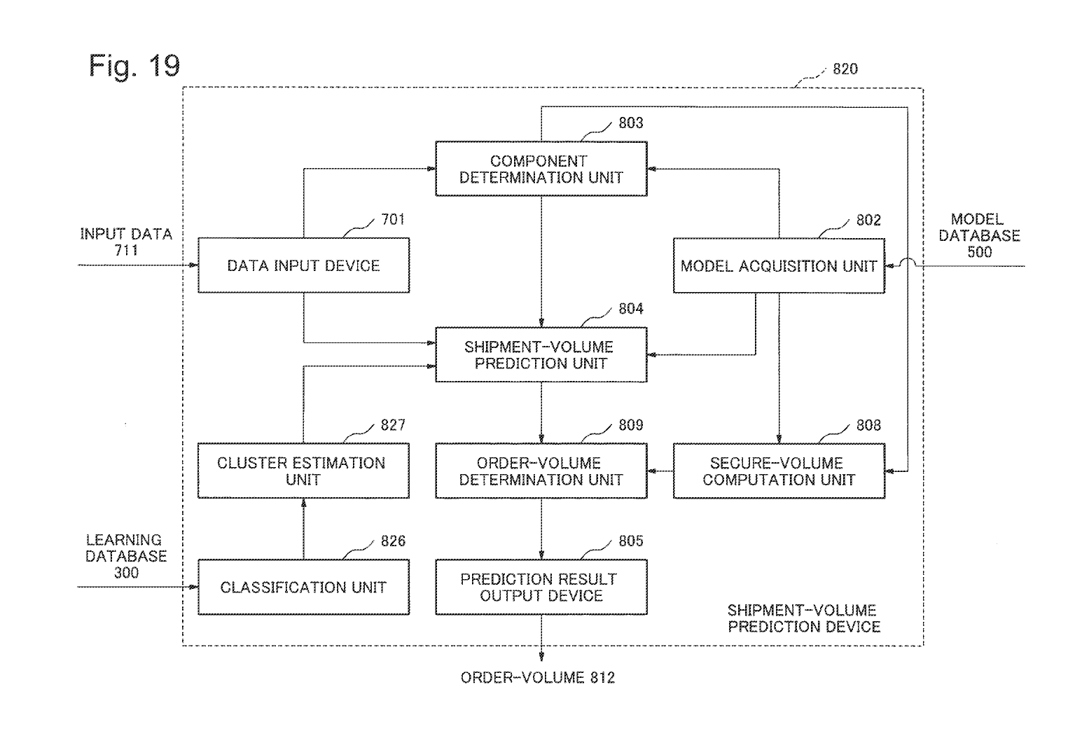

FIG. 19 is a block diagram illustrating an exemplary configuration of a shipment-volume prediction device according to at least one exemplary embodiment. In the shipment-volume prediction system according to this exemplary embodiment, compared to the shipment-volume prediction system according to the fourth exemplary embodiment, the shipment-volume prediction device 800 is replaced with a prediction device 820 of shipment-volume (a shipment-volume prediction device 820). In the shipment-volume prediction device 820, compared to the shipment-volume prediction device 800, the classification unit 806 is replaced with a classification unit 826 and the cluster estimation unit 807 is replaced with a cluster estimation unit 827.

The classification unit 826 classifies existing stores into a plurality of clusters on the basis of information associated with the shipment-volume. The classification unit 826 classifies existing stores into clusters in accordance with, for example, the k-means algorithm or various types of hierarchical clustering algorithms. The classification unit 826 classifies existing stores into clusters on the basis of, for example, a coefficient representing a component acquired by a model acquisition unit 802 or another type of information (learning result model). The component is information for predicting the shipment-volumes in the existing stores. In other words, the classification unit 826 classifies a plurality of existing stores into a plurality of clusters on the basis of the similarity of learning result models for the existing stores. This keeps small variations in tendency of shipment for each store in the same cluster.

The cluster estimation unit 827 estimates a relationship that associates the clusters used for classification by the classification unit 826 with the store attributes.

For the sake of convenience, it is assumed that each cluster is associated with a cluster identifier that allows unique identification of this cluster.

With the above-mentioned process, the cluster estimation unit 827 receives, as input, a store attribute (that is, an explanatory variable) and a cluster identifier (that is, a target variable) and estimates a function mapping the explanatory variable to target variable. The cluster estimation unit 827 estimates the function in accordance with, for example, the procedure of supervised learning such as the c4.5 decision tree algorithm or the support vector machine. The cluster estimation unit 827 estimates a cluster identifier of a cluster including a new store on the basis of the estimated relationship and the store attribute of the new store. In other words, the cluster estimation unit 827 estimates a specific cluster including the new store.

As described above, according to this exemplary embodiment, the shipment-volume prediction device 820 can predict the shipment-volume of a product on the basis of a cluster including an existing store similar (or identical) in tendency of shipment to a new store.

This exemplary embodiment assumes that the classification unit 826 classifies existing stores into clusters on the basis of, for example, a coefficient representing a component acquired by the model acquisition unit 802, but the present invention is not limited to this. For example, in other exemplary embodiments, the classification unit 826 may compute the shipment-rate (for example, the PI (Purchase_Index) value) per client for each product category (for example, stationery and drinks) in each existing store in accordance with information stored in a shipment-table within a learning database 300, and classify existing stores into clusters on the basis of the obtained shipment-rate.

### Sixth Exemplary Embodiment

A sixth exemplary embodiment of a shipment-volume prediction system will be described next.

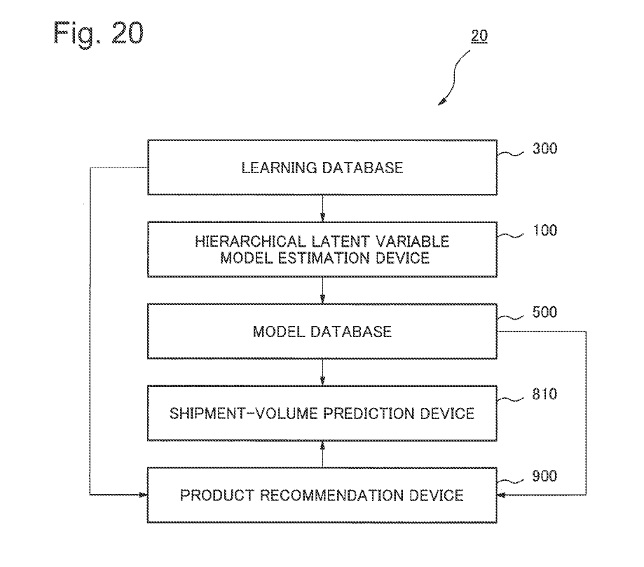

FIG. 20 is a block diagram illustrating an exemplary configuration of a shipment-volume prediction system according to at least one exemplary embodiment. A shipment-volume prediction system 20 according to this exemplary embodiment is provided by adding a product recommendation device 900 to the shipment-volume prediction system according to the fifth exemplary embodiment.

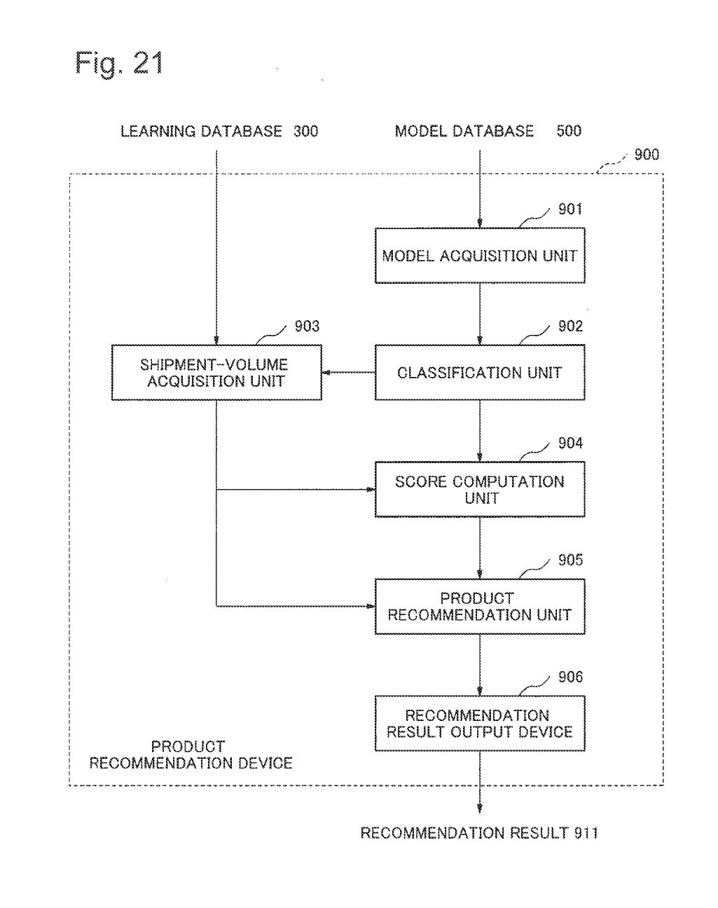

FIG. 21 is a block diagram illustrating an exemplary configuration of a product recommendation device according to at least one exemplary embodiment.

The product recommendation device 900 includes a model acquisition unit 901, a classification unit 902, a shipment-volume acquisition unit 903, a score calculation processing unit 904 (a score computation unit 904), a product recommendation unit 905, and an output device 906 of a result of recommendation (a recommendation result output device 906).

The model acquisition unit 901 acquires a component for each store from a model database 500.

The classification unit 902 classifies existing stores into a plurality of clusters on the basis of, for example, a coefficient representing the component acquired by the model acquisition unit 901.

The shipment-volume acquisition unit 903 acquires, from a shipment table in a learning database 300, the shipment-volumes of respective products being dealt at stores in the cluster including the target store for recommendation. The cluster including the stores also includes this target store for recommendation.

The score computation unit 904 computes a score for a product being dealt at stores in the cluster, which includes the target store for recommendation, classified by the classification unit 902. The score increases (monotonically increases) in accordance with the shipment-volume and the number of stores where the product in question is being dealt. Examples of the score may include the product of the PI value and the number of stores where the product in question is being dealt, and the sum of the normalized PI value and the normalized number of stores where the product in question is being dealt.

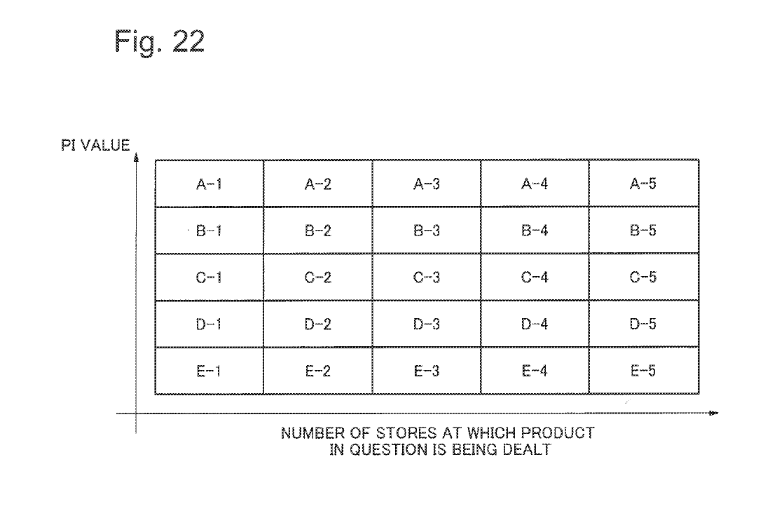

FIG. 22 is a chart illustrating an exemplary tendency of sales of products in a cluster.

Products being dealt at a plurality of stores can be classified as shown in FIG. 22, based on the PI value and the number of stores where the product in question is being dealt. FIG. 22 shows the number of stores where the product in question is being dealt on the horizontal axis and the PI value on the vertical axis. Products associated with A-1 to A-2 or B-1 to B-2 on the upper left of FIG. 22 are relatively hot-selling. Products associated with A-4 to A-5 or B-4 to B-5 on the upper right of FIG. 22 are hot-selling only in some stores. In other words, the products associated with the latter area do not necessarily suit everyone's taste. Products associated with D-1 to D-5 or E-1 to E-5 in the lower area are shelf warmers.

The score computation unit 904 computes, as a score, a value which increases in accordance with the shipment-volume and the number of stores where the product in question is being dealt. The score can be expressed as, for example, the sum of the result of multiplying the PI value by a predetermined coefficient and the result of multiplying the ratio of stores where the product in question is being dealt by a predetermined coefficient. The ratio of stores where the product in question is being dealt is the result of dividing the number of stores where the product in question is being dealt by the total number of stores. This means that products associated with areas closer to the upper left of FIG. 22 have higher scores, while products associated with areas closer to the lower right of FIG. 22 have lower scores. Therefore, products exhibiting higher scores are selling better.

The product recommendation unit 905 selects a product recommended to replace another product whose shipment-volume, which is acquired by the shipment-volume acquisition unit 903, is equal to or smaller than a predetermined threshold from the products being dealt at the target store. More specifically, the product recommendation unit 905 recommends that a product having a small shipment-volume should be replaced with another product having a score higher than that of the former product. In this exemplary embodiment, the product recommendation unit 905 recommends, for example, the replacement of a product whose shipment-volume, which is acquired by the shipment-volume acquisition unit 903, accounts for the bottom 20% of all products.

The recommendation result output device 906 outputs a recommendation result 911 representing the information output from the product recommendation unit 905.

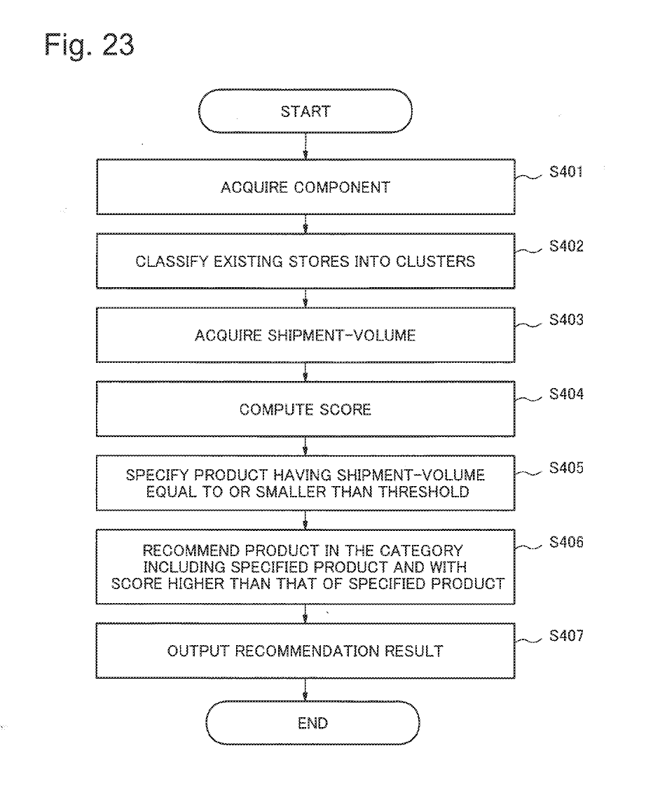

FIG. 23 is a flowchart illustrating an exemplary operation of the product recommendation device according to at least one exemplary embodiment.

The model acquisition unit 901 first acquires components for all existing stores from the model database 500 (step S401). The classification unit 902 classifies the existing stores into a plurality of clusters on the basis of coefficients representing the components acquired by the model acquisition unit 901 (step S402). For example, the classification unit 902 computes the degree of similarity among the existing stores on the basis of the component coefficients.

The shipment-volume acquisition unit 903 acquires, from the learning database 300, the shipment-volumes of products being dealt at the existing stores in the cluster including the target store (step S403). The score computation unit 904 computes a score for each product whose shipment-volume has been acquired by the shipment-volume acquisition unit 903 (step S404). The product recommendation unit 905 specifies a product having a shipment-volume smaller than a predetermined threshold (a product accounting for the bottom 20% of all products) on the basis of the shipment-volumes acquired by the shipment-volume acquisition unit 903 (step S405).

The product recommendation unit 905 determines, for example, as a recommended product to replace a target product having a shipment-volume accounting for the bottom 20%, a product having a score higher than that of the other product in the same category as the other product (step S406). The recommendation result output device 906 outputs a recommendation result 911 obtained by the product recommendation unit 905 (step S407). The supervisor or another type of personnel of the target store determines a product to be dealt at this target store in accordance with the recommendation result 911. For the product to be dealt determined on the basis of the recommendation result 911, a prediction device 810 of shipment-volume (a shipment-volume prediction device 810) performs a process for predicting a shipment-volume and a process for determining an order-volume, as shown in the first to fifth exemplary embodiments.

As described above, according to this exemplary embodiment, the product recommendation device 900 can recommend products that are hot-selling in many stores instead of products dealt in well only in some stores.

This exemplary embodiment assumes that the product recommendation device 900 recommends a product to replace another product being dealt at existing stores, but the present invention is not limited to this. For example, in other exemplary embodiments, the product recommendation device 900 may recommend a product to be additionally introduced into existing stores. For example, in still other exemplary embodiments, the product recommendation device 900 may recommend products to be dealt at new stores.

Furthermore, this exemplary embodiment assumes that the classification unit 902 performs classification into clusters on the basis of the components stored in the model database 500, but the present invention is not limited to this. For example, in other exemplary embodiments, the classification unit 902 may perform clustering on the basis of the store attribute. For example, in still other exemplary embodiments, the classification unit 902 may perform clustering on the basis of the PI value for each product category.

Moreover, this exemplary embodiment assumes that the score computation unit 904 computes a score on the basis of the shipment-volume and the number of stores where the product in question is being dealt, but the present invention is not limited to this. For example, in other exemplary embodiments, the score computation unit 904 may store scores obtained by several previous recommendation operations for each product and update the current score on the basis of a change of the stored scores. In other words, the score computation unit 904 may compute, as a score, for example, the result of adding a correction value obtained by multiplying the difference between the current score and the past score by a predetermined coefficient to the current score computed based on the shipment-volume and the number of stores where the product in question is being dealt. The score can be calculated as, for example:

Score=Current Score+a₁×(Current Score−First-previous Score)+a_{z}×(Current Score−Second-previous Score)+ . . . +aₙ×(Current Score−nth-previous Score) (Eqn. B),

where the coefficients a₁ to aₙ are values determined in advance.

### <<Basic Configuration>>

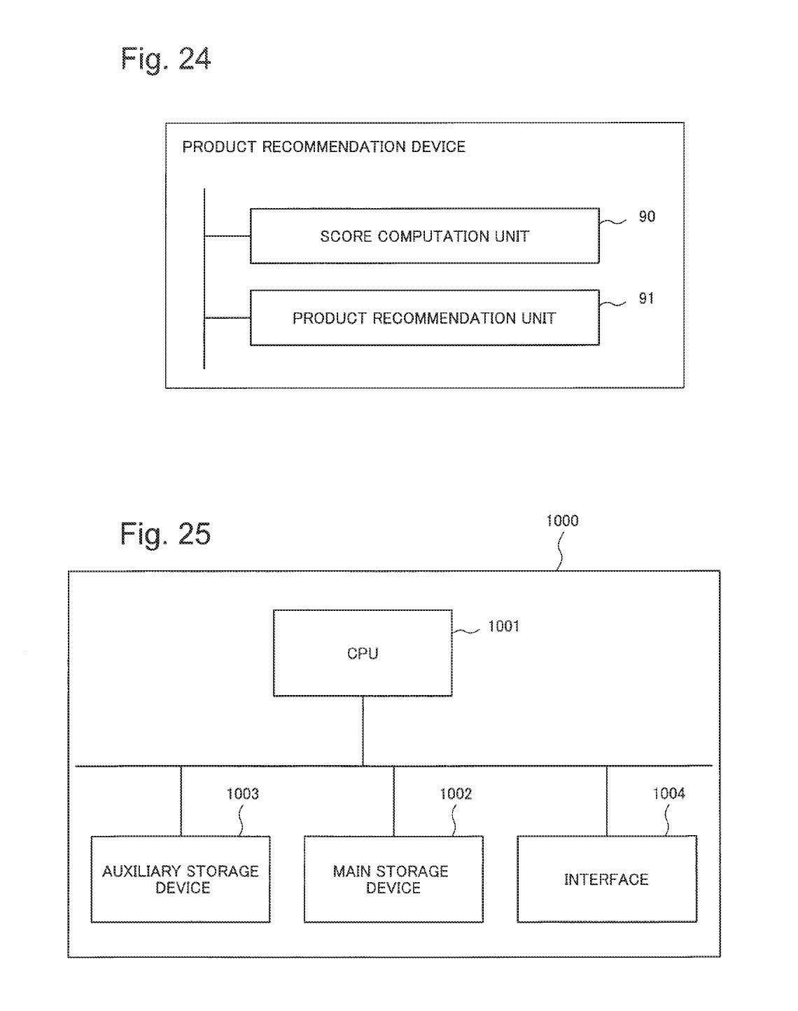

The basic configuration of the product recommendation device will be described below. FIG. 24 is a block diagram illustrating the basic configuration of the product recommendation device.

The product recommendation device includes a score computation unit 90 and a product recommendation unit 91.

The score computation unit 90 computes a score, which increases (monotonically increases) in accordance with the shipment-volume and the number of stores where the product in question is being dealt, for each of a plurality of products being dealt at a plurality of stores. Examples of the score computation unit 90 may include a score computation unit 904.

The product recommendation unit 91 recommends a product having a score higher than that of a product being dealt at the store. Examples of the product recommendation unit 91 may include a product recommendation unit 905.

With such a configuration, the product recommendation device can recommend products that are hot-selling in many stores, in place of products that are selling well only in some stores.

FIG. 25 is a block diagram illustrating the configuration of a computer according to at least one exemplary embodiment.

A computer 1000 includes a CPU 1001, a main storage device 1002, an auxiliary storage device 1003, and an interface 1004.

Each of the above-mentioned hierarchical latent variable model estimation devices and shipment-volume prediction devices is implemented in the computer 1000. The computer 1000 equipped with the hierarchical latent variable model estimation device may be different from the computer 1000 equipped with the order-volume prediction device. The operation of each of the above-mentioned processing units is stored in the auxiliary storage device 1003 in the form of a program (a hierarchical latent variable model estimation program or a shipment-volume prediction program). The CPU 1001 reads the program from the auxiliary storage device 1003 and expands it into the main storage device 1002 to execute the above-mentioned process in accordance with this program.

In at least one exemplary embodiment, the auxiliary storage device 1003 exemplifies a non-transitory tangible medium. Other examples of the non-transitory tangible medium may include a magnetic disk, a magneto-optical disk, a CD (Compact Disc)-ROM (Read Only Memory), a DVD (Digital Versatile Disk)-ROM, and a semiconductor memory connected via the interface 1004. When the program is distributed to the computer 1000 via a communication line, the computer 1000 may, in response to the distribution, expand this program into the main storage device 1002 and execute the above-mentioned process.

The program may implement some of the above-mentioned functions. Further, the program may serve as one which implements the above-mentioned functions in combination with other programs already stored in the auxiliary storage device 1003, that is, a so-called difference file (difference program).

The present invention has been described above by taking the above-described exemplary embodiments as exemplary examples. However, the present invention is not limited to the above-described exemplary embodiments. In other words, the present invention can adopt various modes which would be understood by those skilled in the art without departing from the scope of the present invention.

This application claims priority based on Japanese Patent Application No. 2013-195966 filed on Sep. 20, 2013, the disclosure of which is incorporated herein by reference in its entirety.

### REFERENCE SIGNS LIST

10: shipment-volume prediction system
20: shipment-volume prediction system
100: hierarchical latent variable model estimation device
101: data input device
102: hierarchical latent structure setting unit
103: initialization unit
104: hierarchical latent variable variational probability computation unit
105: component optimization unit
106: gating function optimization unit
107: optimality determination unit
108: optimal model selection unit
109: model estimation result output device
111: input data
112: model estimation result
104-1: lowest-level path latent variable variational probability computation unit
104-2: hierarchical setting unit
104-3: higher-level path latent variable variational probability computation unit
104-4: hierarchical computation end determination unit
104-5: estimated model
104-6: hierarchical latent variable variational probability
106-1: branch node information acquisition unit
106-2: branch node selection unit
106-3: branch parameter optimization unit
106-4: total branch node optimization end determination unit
106-6: gating function model
113: gating function optimization unit
113-1: effective branch node selection unit
113-2: branch parameter optimization parallel processing unit
200: hierarchical latent variable model estimation device
201: hierarchical latent structure optimization unit
201-1: path latent variable summation operation unit
201-2: path removal determination unit
201-3: path removal execution unit
300: learning database
100: hierarchical latent variable model estimation device
500: model database
700: shipment-volume prediction device
701: data input device
702: model acquisition unit
703: component determination unit
704: shipment-volume prediction unit
705: prediction result output device
711: input data
712: prediction result
800: shipment-volume prediction device
820: shipment-volume prediction device
802: model acquisition unit
803: component determination unit
804: shipment-volume prediction unit
805: prediction result output device
806: classification unit
826: classification unit
812: order-volume
810: shipment-volume prediction device
807: cluster estimation unit
827: cluster estimation unit
808: secure-volume computation unit
809: order-volume determination unit
900: product recommendation device
901: model acquisition unit
902: classification unit
903: shipment-volume acquisition unit
904: score computation unit
905: product recommendation unit
906: recommendation result output device
911: recommendation result
90: score computation unit
91: product recommendation unit
1000: computer
1001: CPU
1002: main storage device
1003: auxiliary storage device
1004: interface

1. A product recommendation device which recommending a product to be dealt at a store, the device comprising:
a score computation unit configured to calculate a score which increases in accordance with a shipment-volume and the number of stores where a product in question is being dealt, for a plurality of products being dealt at a plurality of stores; and
a product recommendation unit configured to recommend a product having the higher score than the score of a product being dealt at the store for which the recommendation is being made.

2. The product recommendation device according to claim 1, further comprising:
a classification unit configured to classify the plurality of stores into a plurality of clusters,
wherein the score computation unit computes the score with respect to the shipment-volume and the number of stores, where the product in question is being dealt, for a plurality of products being dealt at a store in a cluster including the store for which the recommendation is being made, belongs.

3. The product recommendation device according to claim 2, wherein the classification unit classifies the plurality of stores into a plurality of clusters on the basis of a probability model used to predict the shipment-volume of the product.

4. The product recommendation device according to claim 1, wherein
the product recommendation unit recommends that a product having a shipment-volume smaller than a predetermined threshold, of the product being dealt at the store for which the recommendation is being made, should be replaced with another product, the score of which is higher than the score of the product having the smaller shipment-volume.

5. The product recommendation device according to claim 1, wherein
the score computation unit computes the score by adding, to a main score computed based on the shipment-volume and the number of stores where the product in question is being dealt, a correction value obtained by multiplying a difference between the main score and a past score by a predetermined coefficient.

6. A product recommendation method comprising:
using an information processing apparatus
calculating a score which increases in accordance with a shipment-volume and the number of stores where a product in question is being dealt, for a plurality of products being dealt at a plurality of stores; and thereby
recommending a product having the higher score than the score of a product being dealt at a store for which the recommendation is being made.

7. A non-transitory recording medium recording a program for causing a computer to execute:
a score computation function configured to calculate a score which increases in accordance with a shipment-volume and the number of stores where a product in question is being dealt, for a plurality of products being dealt at a plurality of stores; and
a product recommendation function configured to recommend a product having the higher score than the score of a product being dealt at the store for which the recommendation is being made.
